(19) United States
(12) Patent Application Publication
(10) Pub. No.: US 2012/0262424 A1
(43) Pub. Date: Oct. 18, 2012

(54) Display Device

(75) Inventors: Kohhei Tanaka, Osaka (JP); Yasuhiro Sugita, Osaka (JP); Kaoru Yamamoto, Osaka (JP); Christopher Brown, Osaka (JP)

(73) Assignee: SHARP KABUSHIKI KAISHA, Osaka-shi, Osaka (JP)

(21) Appl. No.: 13/497,268

(22) PCT Filed: Jun. 8, 2010
(86) PCT No.: PCT/JP2010/059686

§ 371 Date: Mar. 21, 2012

(30) Foreign Application Priority Data
Sep. 30, 2009 (JP) 2009-226567

(51) Int. Cl. G06F 3/042

(52) U.S. Cl. 345/175

(57) ABSTRACT

A plurality of sensor pixel circuits each including two photodiodes, one accumulation node accumulating charge corresponding to an amount of light, and a read transistor having a control terminal connected to the accumulation node are arranged in a pixel region. In accordance with a clock signal, when a backlight is turned on, a transistor turns on, a current flows through the photodiode, and a potential at the accumulation node drops. When the backlight is turned off, a transistor turns on, a current flows through the photodiode, and the potential at the accumulation node rises. Sensitivity characteristics of the two photodiodes may be changed using the clock signal. The sensor pixel circuit described above is used for detecting a difference between an amount of light to be incident when the backlight is turned on and an amount of light to be incident when the backlight is turned off.

### TECHNICAL FIELD

The present invention relates to display devices, and more particularly to a display device in which a plurality of optical sensors are arranged in a pixel region.

### BACKGROUND ART

With regard to display devices, heretofore, there have been known methods of providing input functions such as touch panels, pen input and scanners in such a manner that a plurality of optical sensors are provided on a display panel. In order to adapt such a method to a mobile appliance to be used under various light environments, it is necessary to eliminate an influence of the light environment. Therefore, there has also been known a method of removing a component depending on a light environment from a signal sensed by an optical sensor to obtain a signal to be input intrinsically.

Patent Document 1 describes an input/output device in which light receiving elements are provided corresponding to individual displaying elements. In the input/output device, a backlight is turned on and off once in a one-frame period, and reset for and read from the light receiving elements are performed in a line sequential manner so that an amount of light during a backlight turn-on period and an amount of light during a backlight turn-off period are obtained from all the light receiving elements in the one-frame period.

FIG. 31 is a diagram showing turn-on and turn-off timings of the backlight as well as reset and read timings of the light receiving elements, in Patent Document 1. As shown in FIG. 31, in the one-frame period, the backlight is turned on in the former half and is turned off in the latter half. During the backlight turn-on period, the reset for the light receiving elements is performed in a line sequential manner (a solid line arrow), and then the read from the light receiving elements is performed in a line sequential manner (a broken line arrow). Also during the backlight turn-off period, the reset for and read from the light receiving elements are performed in the similar manner.

Patent Document 2 describes a solid-state imaging device including a unit light receiving section shown in FIG. 32. As shown in FIG. 32, the unit light receiving section includes one photoelectric converting part PD, and two charge accumulating parts C1 and C2. In the case of receiving both external light and light which is emitted from light emitting means and then is reflected from a physical object, a first sample gate SG1 turns on, and charge generated by the photoelectric converting part PD is accumulated in the first charge accumulating part C1. In the case of receiving only external light, a second sample gate SG2 turns on, and the charge generated by the photoelectric converting part PD is accumulated in the second charge accumulating part C2. It is possible to obtain a difference between the amounts of charge accumulated in the two charge accumulating parts C1 and C2, thereby obtaining an amount of light which is emitted from the light emitting means and then is reflected from the physical object.

### PRIOR ART DOCUMENTS

### Patent Documents

Patent Document 1: Japanese Patent No. 4072732
Patent Document 2: Japanese Patent No. 3521187

### SUMMARY OF THE INVENTION

### Problems to be Solved by the Invention

In a typical display device in which a plurality of optical sensors are provided on a display panel, read from the optical sensors is performed in a line sequential manner. Moreover, backlights for a mobile appliance are turned on simultaneously and are turned off simultaneously as an entire screen.

In the input/output device described in Patent Document 1, the backlight is turned on and off once in the one-frame period. During the backlight turn-on period, a period for the reset does not overlap with a period for the read. Also during the backlight turn-off period, a period for the reset does not overlap with a period for the read. Consequently, the read from the light receiving elements needs to be performed within a ¼-frame period (for example, within 1/240 seconds in the case where a frame rate is 60 frames per second). In an actual fact, however, it is considerably difficult to perform the high-speed read described above.

Moreover, there is a deviation corresponding to a ½-frame period between a period (B1 shown in FIG. 31) during which the light receiving element senses light in the backlight turn-on period and a period (B2 shown in FIG. 31) during which the light receiving element senses light in the backlight turn-off period. Consequently, followability to motion input varies in accordance with a direction of the input. Moreover, this input/output device starts to perform the read immediately after completion of the reset, and starts to perform the reset immediately after completion of the read. Consequently, it is impossible to freely set a length and an interval with regard to the backlight turn-on period and the backlight turn-off period.

Moreover, in this input/output device, an amount of light during the backlight turn-on period and an amount of light during the backlight turn-off period are detected by the same light receiving element. Consequently, in the case where a certain light receiving element detects an amount of light during the backlight turn-on period, this light receiving element fails to start to detect an amount of light during the backlight turn-off period until the detected amount of light is read from this light receiving element.

Moreover, this input/output device detects the amount of light during the backlight turn-on period and the amount of light during the backlight turn-off period separately. Consequently, in the case where one of the amounts of light is saturated, it is impossible to correctly obtain a difference between the two amounts of light. As a method for preventing the saturation of the amount of light, there are considered a method of lowering the sensitivity of an optical sensor, and a method of shortening a shutter speed (an accumulation time). However, when the sensitivity of the optical sensor is lowered, light amount detection accuracy is degraded. Moreover, it is difficult to adjust the shutter speed because a frame rate is determined previously in many cases.

Hence, it is an object of the present invention to provide a display device that solves the problems described above, and has an input function which does not depend on light environments.

### Means for Solving the Problems

According to a first aspect of the present invention, there is provided a display device in which a plurality of optical sensors are arranged in a pixel region, the display device including: a display panel that includes a plurality of display pixel circuits and a plurality of sensor pixel circuits; and a drive circuit that outputs, to the sensor pixel circuits, a control signal indicating that a light source is turned on or the light source is turned off, wherein the sensor pixel circuit includes: a first optical sensor; a second optical sensor; one accumulation node accumulating charge corresponding to an amount of sensed light; and a read transistor having a control terminal connected to the accumulation node, and the sensor pixel circuit is configured so that, in accordance with the control signal, a potential at the accumulation node is changed in a predetermined direction by a current flowing through the first optical sensor when the light source is turned on and is changed in the reverse direction by a current flowing through the second optical sensor when the light source is turned off.

According to a second aspect of the present invention, in the first aspect of the present invention, the sensor pixel circuit further includes: a first switching element that is provided on a path for the current flowing through the first optical sensor and turns on, in accordance with the control signal, when the light source is turned on; and a second switching element that is provided on a path for the current flowing through the second optical sensor and turns on, in accordance with the control signal, when the light source is turned off.

According to a third aspect of the present invention, in the second aspect of the present invention, the first optical sensor is provided between the accumulation node and one of ends of the first switching element, the second optical sensor is provided between the accumulation node and one of ends of the second switching element, the other end of the first switching element is connected to a reset line, and the other end of the second switching element is applied with a predetermined potential.

According to a fourth aspect of the present invention, in the second aspect of the present invention, the first switching element is provided between the accumulation node and one of ends of the first optical sensor, the second switching element is provided between the accumulation node and one of ends of the second optical sensor, the other end of the first optical sensor is connected to a reset line, and the other end of the second optical sensor is applied with a predetermined potential.

According to a fifth aspect of the present invention, in the third aspect of the present invention, the sensor pixel circuit further includes: a third switching element that has one of ends connected to a first switching element side terminal of the first optical sensor and turns on, in accordance with the control signal, when the light source is turned off; a fourth switching element that has one of ends connected to a second switching element side terminal of the second optical sensor and turns on, in accordance with the control signal, when the light source is turned on; a fifth switching element supplying the other end of the third switching element with a potential corresponding to the potential at the accumulation node; and a sixth switching element supplying the other end of the fourth switching element with a potential corresponding to the potential at the accumulation node.

According to a sixth aspect of the present invention, in the second aspect of the present invention, the sensor pixel circuit further includes a capacitor provided between the accumulation node and a read line.

According to a seventh aspect of the present invention, in the first aspect of the present invention, the first and second optical sensors have sensitivity characteristics that, in accordance with the control signal, the current flowing through the first optical sensor becomes larger in amount than the current flowing through the second optical sensor when the light source is turned on, and the current flowing through the second optical sensor becomes larger in amount than the current flowing through the first optical sensor when the light source is turned off.

According to an eighth aspect of the present invention, in the seventh aspect of the present invention, a control line for propagating the control signal is connected to a light shielding film formed for the first and second optical sensors, via a capacitor.

According to a ninth aspect of the present invention, in the seventh aspect of the present invention, a control line for propagating the control signal is electrically connected to a light shielding film formed for the first and second optical sensors.

According to a tenth aspect of the present invention, in the seventh aspect of the present invention, the sensitivity characteristics of the first and second optical sensors change in different manners in accordance with the control signal, and the same control signal is supplied to the first and second optical sensors.

According to an eleventh aspect of the present invention, in the seventh aspect of the present invention, the sensitivity characteristics of the first and second optical sensors change in the same manner in accordance with the control signal, and an inverted signal of the control signal to be supplied to the first optical sensor is supplied to the second optical sensor.

According to a twelfth aspect of the present invention, in the seventh aspect of the present invention, the sensor pixel circuit further includes: a capacitor provided between the accumulation node and a read line; and a switching element that is provided between the accumulation node and one of ends of the second optical sensor and turns off when a potential for read is applied to the read line, the first optical sensor is provided between the accumulation node and a reset line, and the other end of the second optical sensor is applied with a predetermined potential.

According to a thirteenth aspect of the present invention, in the first aspect of the present invention, the drive circuit outputs, as the control signal, a signal indicating that the light source is turned on and the light source is turned off a plurality of times, respectively, in a one-frame period.

According to a fourteenth aspect of the present invention, there is provided a sensor pixel circuit to be arranged in a pixel region of a display device, the sensor pixel circuit including: a first optical sensor; a second optical sensor; one accumulation node accumulating charge corresponding to an amount of sensed light; and a read transistor having a control terminal connected to the accumulation node, wherein the sensor pixel circuit is configured so that, in accordance with a control signal indicating that a light source is turned on or the light source is turned off, a potential at the accumulation node is changed in a predetermined direction by a current flowing through the first optical sensor when the light source is turned on and is changed in the reverse direction by a current flowing through the second optical sensor when the light source is turned off.

### Effects of the Invention

According to the first aspect of the present invention, the sensor pixel circuit includes the two optical sensors and the one accumulation node, and the potential at the accumulation node changes in reverse direction when the light source is turned on and when the light source is turned off. Accordingly, it is possible to detect a difference between an amount of light when the light source is turned on and an amount of light when the light source is turned off, by use of one sensor pixel circuit, and to provide an input function which does not depend on light environments. Moreover, the difference between the amounts of light is detected by use of one sensor pixel circuit. As compared with the case of detecting two types of amounts of light separately, therefore, it is possible to prevent the amount of light from being saturated and to correctly obtain the difference between the amounts of light since. Moreover, as compared with the case of detecting two types of amounts of light sequentially by use of one sensor pixel circuit, it is possible to reduce a frequency of read from the sensor pixel circuits, to retard the read speed, and to reduce power consumption in the device. Moreover, it becomes unnecessary to provide a memory which is required in the case of detecting two types of amounts of light sequentially and is used for storing the amount of light sensed firstly. Moreover, it is possible to increase the degree of freedom for setting turn-on and turn-off timings of the light source as well as reset and read timings of the sensor pixel circuits. Moreover, in case of using a suitable driving method, it is possible to eliminate a deviation between a sensing period when the light source is turned on and a sensing period when the light source is turned off, and to prevent followability to motion input from varying in accordance with a direction of the input. Moreover, by obtaining the difference between the amounts of light by use of one sensor pixel circuit, it is possible to perform temperature compensation at the same time.

According to the second aspect of the present invention, when the light source is turned on, the first switching element turns on, so that the current flows through the first optical sensor. When the light source is turned off, the second switching element turns on, so that the current flows through the second optical sensor. Accordingly, by setting a potential at the reset line and the predetermined potential appropriately, it is possible to constitute the sensor pixel circuit in which the potential at the accumulation node changes in reverse direction when the light source is turned on and when the light source is turned off and which is allowed to detect the difference between the amount of light when the light source is turned on and the amount of light when the light source is turned off.

According to the third aspect of the present invention, the two optical sensors are connected to the accumulation node, and the switching element which turns on when the light source is turned on and the switching element which turns on when the light source is turned off are connected to the two optical sensors. Thus, it is possible to constitute the sensor pixel circuit which is allowed to detect the difference between the amount of light when the light source is turned on and the amount of light when the light source is turned off.

According to the fourth aspect of the present invention, the switching element which turns on when the light source is turned on is provided between the accumulation node and one of the optical sensors, and the switching element which turns on when the light source is turned off is provided between the accumulation node and the other optical sensor. Thus, it is possible to constitute the sensor pixel circuit which is allowed to detect the difference between the amount of light when the light source is turned on and the amount of light when the light source is turned off. Moreover, in the case of changing the potential at the accumulation node to perform read, the optical sensor on the side of the switching element which is in the OFF state is disconnected electrically from the accumulation node. Accordingly, it is possible to reduce a capacitance of the accumulation node at the time of read, and to readily change the potential at the accumulation node.

According to the fifth aspect of the present invention, by applying the potential corresponding to the potential at the accumulation node to the terminal, which is opposed to the accumulation node, of the optical sensor upon change of the control signal, it is possible to immediately interrupt the current flowing through the optical sensor, and to enhance detection accuracy.

According to the sixth aspect of the present invention, by applying the potential for read to the read line, it is possible to change the potential at the accumulation node, and to read a signal corresponding to the amount of sensed light from the sensor pixel circuit.

According to the seventh aspect of the present invention, a relation in amount between the currents flowing through the two optical sensors differs when the light source is turned on and when the light source is turned off. Accordingly, by setting the potential at the reset line and the predetermined potential appropriately, it is possible to constitute the sensor pixel circuit in which the potential at the accumulation node changes in reverse direction when the light source is turned on and when the light source is turned off and which is allowed to detect the difference between the amount of light when the light source is turned on and the amount of light when the light source is turned off.

According to the eighth aspect of the present invention, the light shielding film of the optical sensor is connected to the control line via the capacitor. Thus, when a potential at the control line changes, a potential at the light shielding film changes, and the sensitivity characteristics of the optical sensor change. Accordingly, it is possible to constitute the sensor pixel circuit in which the relation in amount between the currents flowing through the two optical sensors differs when the light source is turned on and when the light source is turned off and which is allowed to detect the difference between the amount of light when the light source is turned on and the amount of light when the light source is turned off.

According to the ninth aspect of the present invention, the light shielding film of the optical sensor is electrically connected to the control line. Thus, when the potential at the control line changes, the potential at the light shielding film changes, and the sensitivity characteristics of the optical sensor change. Accordingly, it is possible to constitute the sensor pixel circuit in which the relation in amount between the currents flowing through the two optical sensors differs when the light source is turned on and when the light source is turned off and which is allowed to detect the difference between the amount of light when the light source is turned on and the amount of light when the light source is turned off.

According to the tenth aspect of the present invention, by controlling the two optical sensors which are different in sensitivity characteristics from each other, using the same control signal, it is possible to constitute the sensor pixel circuit in which the relation in amount between the currents flowing through the two optical sensors differs when the light source is turned on and when the light source is turned off and which is allowed to detect the difference between the amount of light when the light source is turned on and the amount of light when the light source is turned off.

According to the eleventh aspect of the present invention, by controlling the two optical sensors which are equal in sensitivity characteristics to each other, using the different control signals, it is possible to constitute the sensor pixel circuit in which the relation in amount between the currents flowing through the two optical sensors differs when the light source is turned on and when the light source is turned off and which is allowed to detect the difference between the amount of light when the light source is turned on and the amount of light when the light source is turned off.

According to the twelfth aspect of the present invention, the optical sensor and the switching element are connected to the accumulation node, and another optical sensor is connected to the switching element. Thus, it is possible to constitute the sensor pixel circuit which is allowed to detect the difference between the amount of light when the light source is turned on and the amount of light when the light source is turned off. Moreover, the two optical sensors are electrically connected to the accumulation node every time during the sensing period. Therefore, it is possible to prevent errors due to left charge, and to enhance detection accuracy.

According to the thirteenth aspect of the present invention, by performing the operation of sensing light when the light source is turned on and the operation of sensing light when the light source is turned off a plurality of times, respectively, in the one-frame period, it is possible to prevent the amount of light from being saturated, and to correctly obtain the difference between the amounts of light. Moreover, it is possible to eliminate the deviation between the sensing period when the light source is turned on and the sensing period when the light source is turned off, and to prevent followability to motion input from varying in accordance with a direction of the input.

According to the fourteenth aspect of the present invention, it is possible to constitute the sensor pixel circuit to be included in the display device according to the first aspect, and to provide the display device having an input function which does not depend on light environments.

### BRIEF DESCRIPTION OF THE DRAWINGS

FIG. 1 is a block diagram showing a configuration of a display device according to one embodiment of the present invention.

FIG. 2 is a diagram showing an arrangement of sensor pixel circuits on a display panel included in the display device shown in FIG. 1.

FIG. 3 is a diagram showing turn-on and turn-off timings of a backlight as well as reset and read timings of the sensor pixel circuits, in the display device shown in FIG. 1.

FIG. 4 is a signal waveform diagram of the display panel included in the display device shown in FIG. 1.

FIG. 5 is a diagram showing a schematic configuration of the sensor pixel circuit included in the display device shown in FIG. 1.

FIG. 6 is a circuit diagram of a sensor pixel circuit according to a first embodiment of the present invention.

FIG. 7A is a layout diagram of the sensor pixel circuit shown in FIG. 6.

FIG. 7B is another layout diagram of the sensor pixel circuit shown in FIG. 6.

FIG. 8 is a diagram showing operations of the sensor pixel circuit shown in FIG. 6.

FIG. 9 is a signal waveform diagram of the sensor pixel circuit shown in FIG. 6.

FIG. 10 is a circuit diagram of a sensor pixel circuit according to a second embodiment of the present invention.

FIG. 11A is a layout diagram of the sensor pixel circuit shown in FIG. 10.

FIG. 11B is another layout diagram of the sensor pixel circuit shown in FIG. 10.

FIG. 12 is a diagram showing operations of the sensor pixel circuit shown in FIG. 10.

FIG. 13 is a circuit diagram of a sensor pixel circuit according to a third embodiment of the present invention.

FIG. 14A is a layout diagram of the sensor pixel circuit shown in FIG. 13.

FIG. 14B is another layout diagram of the sensor pixel circuit shown in FIG. 13.

FIG. 15 is a diagram showing operations of the sensor pixel circuit shown in FIG. 13.

FIG. 16 is a circuit diagram of a sensor pixel circuit according to a fourth embodiment of the present invention.

FIG. 17A is a layout diagram of the sensor pixel circuit shown in FIG. 16.

FIG. 17B is another layout diagram of the sensor pixel circuit shown in FIG. 16.

FIG. 18 is a diagram showing a situation that a state of a photodiode changes in accordance with a potential at a light shielding film.

FIG. 19 is a diagram showing a relation between the potential at the light shielding film and currents flowing through the photodiode.

FIG. 20 is a diagram showing sensitivity characteristics of the photodiodes included in the sensor pixel circuit shown in FIG. 16.

FIG. 21 is a diagram showing operations of the sensor pixel circuit shown in FIG. 16.

FIG. 22 is a circuit diagram of a sensor pixel circuit according to a fifth embodiment of the present invention.

FIG. 23A is a layout diagram of the sensor pixel circuit shown in FIG. 22.

FIG. 23B is another layout diagram of the sensor pixel circuit shown in FIG. 22.

FIG. 24A is a circuit diagram of a sensor pixel circuit according to a first modification example of the first embodiment.

FIG. 24B is a circuit diagram of a sensor pixel circuit according to a second modification example of the first embodiment.

FIG. 24C is a circuit diagram of a sensor pixel circuit according to a third modification example of the first embodiment.

FIG. 24D is a circuit diagram of a sensor pixel circuit according to a fourth modification example of the first embodiment.

FIG. 24E is a circuit diagram of a sensor pixel circuit according to a fifth modification example of the first embodiment.

FIG. 24F is a circuit diagram of a sensor pixel circuit according to a sixth modification example of the first embodiment.

FIG. 24G is a circuit diagram of a sensor pixel circuit according to a seventh modification example of the first embodiment.

FIG. 25A is a circuit diagram of a sensor pixel circuit according to a first modification example of the second embodiment.

FIG. 25B is a circuit diagram of a sensor pixel circuit according to a second modification example of the second embodiment.

FIG. 25C is a circuit diagram of a sensor pixel circuit according to a third modification example of the second embodiment.

FIG. 25D is a circuit diagram of a sensor pixel circuit according to a fourth modification example of the second embodiment.

FIG. 25E is a circuit diagram of a sensor pixel circuit according to a fifth modification example of the second embodiment.

FIG. 25F is a circuit diagram of a sensor pixel circuit according to a sixth modification example of the second embodiment.

FIG. 25G is a circuit diagram of a sensor pixel circuit according to a seventh modification example of the second embodiment.

FIG. 26A is a circuit diagram of a sensor pixel circuit according to a first modification example of the third embodiment.

FIG. 26B is a circuit diagram of a sensor pixel circuit according to a second modification example of the third embodiment.

FIG. 26C is a circuit diagram of a sensor pixel circuit according to a third modification example of the third embodiment.

FIG. 26D is a circuit diagram of a sensor pixel circuit according to a fourth modification example of the third embodiment.

FIG. 26E is a circuit diagram of a sensor pixel circuit according to a fifth modification example of the third embodiment.

FIG. 26F is a circuit diagram of a sensor pixel circuit according to a sixth modification example of the third embodiment.

FIG. 26G is a circuit diagram of a sensor pixel circuit according to a seventh modification example of the third embodiment.

FIG. 27A is a circuit diagram of a sensor pixel circuit according to a first modification example of the fourth embodiment.

FIG. 27B is a circuit diagram of a sensor pixel circuit according to a second modification example of the fourth embodiment.

FIG. 27C is a circuit diagram of a sensor pixel circuit according to a third modification example of the fourth embodiment.

FIG. 27D is a circuit diagram of a sensor pixel circuit according to a fourth modification example of the fourth embodiment.

FIG. 27E is a circuit diagram of a sensor pixel circuit according to a fifth modification example of the fourth embodiment.

FIG. 27F is a circuit diagram of a sensor pixel circuit according to a sixth modification example of the fourth embodiment.

FIG. 27G is a circuit diagram of a sensor pixel circuit according to a seventh modification example of the fourth embodiment.

FIG. 28A is a circuit diagram of a sensor pixel circuit according to a first modification example of the fifth embodiment.

FIG. 28B is a circuit diagram of a sensor pixel circuit according to a second modification example of the fifth embodiment.

FIG. 28C is a circuit diagram of a sensor pixel circuit according to a third modification example of the fifth embodiment.

FIG. 28D is a circuit diagram of a sensor pixel circuit according to a fourth modification example of the fifth embodiment.

FIG. 28E is a circuit diagram of a sensor pixel circuit according to a fifth modification example of the fifth embodiment.

FIG. 28F is a circuit diagram of a sensor pixel circuit according to a sixth modification example of the fifth embodiment.

FIG. 28G is a circuit diagram of a sensor pixel circuit according to a seventh modification example of the fifth embodiment.

FIG. 29A is a circuit diagram of a sensor pixel circuit according to an eighth modification example of the fourth embodiment.

FIG. 29B is a circuit diagram of a sensor pixel circuit according to an eighth modification example of the fifth embodiment.

FIG. 30 is a diagram showing sensitivity characteristics of photodiodes included in the sensor pixel circuits shown in FIGS. 29A and 29B.

FIG. 31 is a diagram showing turn-on and turn-off timings of a backlight as well as reset and read timings of light receiving elements, in a conventional input/output device.

FIG. 32 is a circuit diagram of a unit light receiving section included in a conventional solid-state imaging device.

### MODES FOR CARRYING OUT THE INVENTION

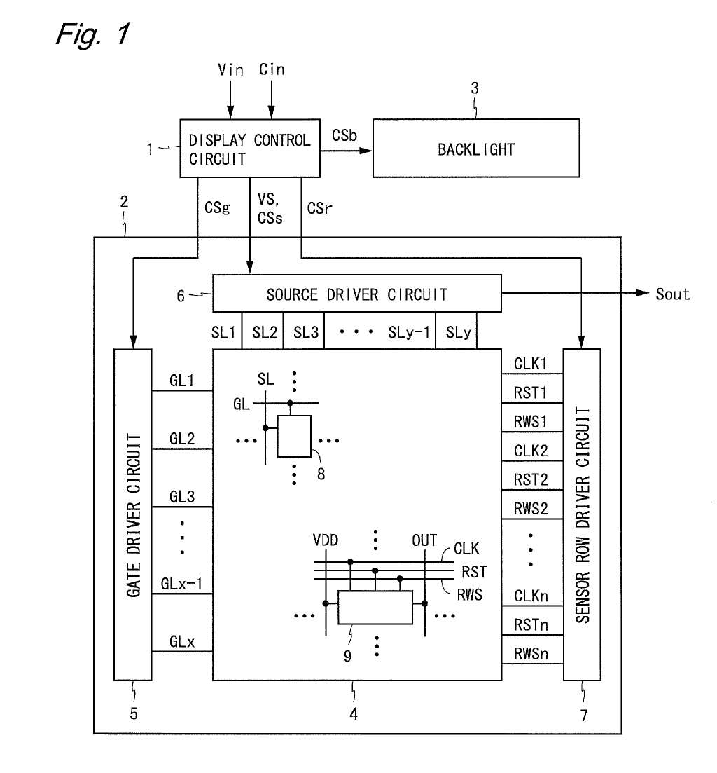

FIG. 1 is a block diagram showing a configuration of a display device according to one embodiment of the present invention. As shown in FIG. 1, the display device includes a display control circuit 1, a display panel 2 and a backlight 3. The display panel 2 includes a pixel region 4, a gate driver circuit 5, a source driver circuit 6 and a sensor row driver circuit 7. The pixel region 4 includes a plurality of display pixel circuits 8 and a plurality of sensor pixel circuits 9. This display device has a function of displaying an image on the display panel 2, and a function of sensing light incident on the display panel 2. In the following definition, x represents an integer of not less than 2, y represents a multiple of 3, m and n each represent an even number, and a frame rate of the display device is 60 frames per second.

To the display device shown in FIG. 1, a video signal Vin and a timing control signal Cin are supplied from the outside. Based on these signals, the display control circuit 1 outputs a video signal VS and control signals CSg, CSs and CSr to the display panel 2, and outputs a control signal CSb to the backlight 3. The video signal VS may be equal to the video signal Vin, or may be a signal corresponding to the video signal Vin subjected to signal processing.

The backlight 3 is a light source for irradiating light to the display panel 2. More specifically, the backlight 3 is provided on a back side of the display panel 2, and irradiates light to the back of the display panel 2. The backlight 3 is turned on when the control signal CSb is in a HIGH level, and is turned off when the control signal CSb is in a LOW level.

In the pixel region 4 of the display panel 2, the (x×y) display pixel circuits 8 and the (n×m/2) sensor pixel circuits 9 are arranged in a two-dimensional array, respectively. More specifically, x gate lines GL1 to GLx and y source lines SL1 to SLy are formed in the pixel region 4. The gate lines GL1 to GLx are arranged in parallel to one another, and the source lines SL1 to SLy are arranged in parallel to one another so as to be orthogonal to the gate lines GL1 to GLx. The (x×y) display pixel circuits 8 are arranged in the vicinity of intersections between the gate lines GL1 to GLx and the source lines SL1 to SLy. Each display pixel circuit 8 is connected to one gate line GL and one source line SL. The display pixel circuits 8 are classified into those for red display, those for green display and those for blue display. These three types of display pixel circuits 8 are arranged and aligned in an extending direction of the gate lines GL1 to GLx to form one color pixel.

In the pixel region 4, n clock lines CLK1 to CLKn, n reset lines RST1 to RSTn and n read lines RWS1 to RWSn are formed in parallel to the gate lines GL1 to GLx. Moreover, in the pixel region 4, other signal lines and power supply lines (not shown) are formed in parallel to the gate lines GL1 to GLx in some cases. In the case where read from the sensor pixel circuits 9 is performed, m source lines selected from among the source lines SL1 to SLy are used as power supply lines VDD1 to VDDm, and different m source lines are used as output lines OUT1 to OUTm.

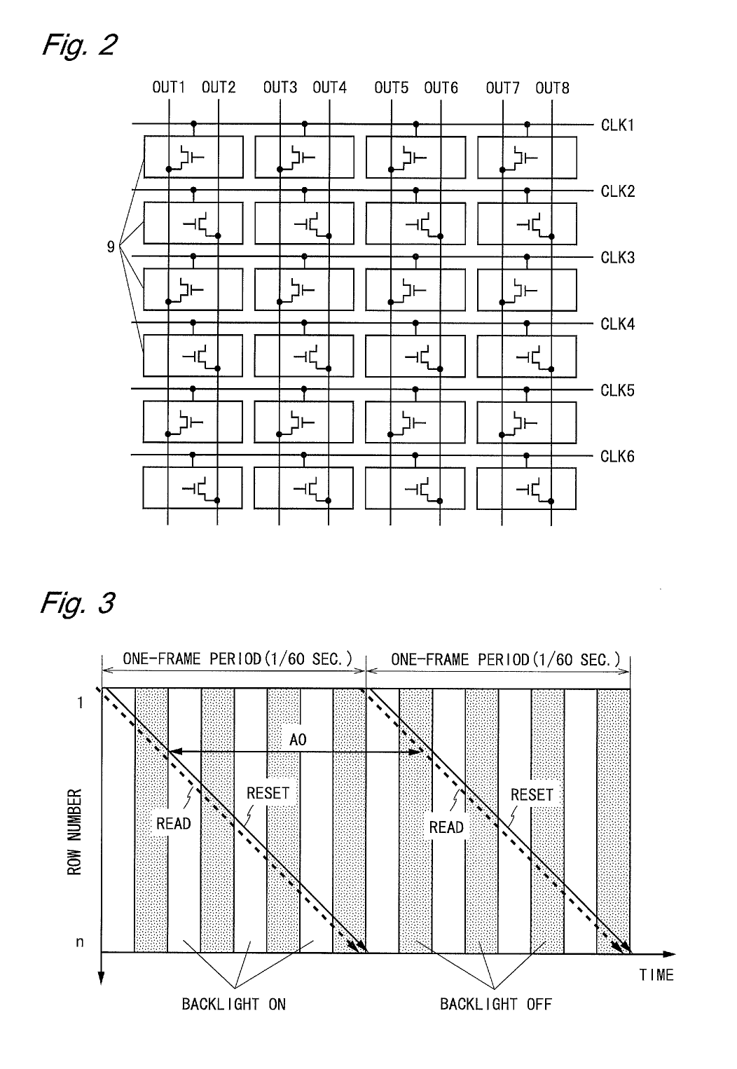

FIG. 2 is a diagram showing an arrangement of the sensor pixel circuits 9 in the pixel region 4. As shown in FIG. 2, the (n×m/2) sensor pixel circuits 9 are arranged in the vicinity of intersections between the odd-numbered clock lines CLK1 to CLKn-1 and the odd-numbered output lines OUT1 to OUTm-1 and in the vicinity of intersections between the even-numbered clock lines CLK2 to CLKn and the even-numbered output lines OUT2 to OUTm.

The gate driver circuit 5 drives the gate lines GL1 to GLx. More specifically, based on the control signal CSg, the gate driver circuit 5 selects one gate line sequentially from among the gate lines GL1 to GLx, applies a HIGH-level potential to the selected gate line, and applies a LOW-level potential to the remaining gate lines. Thus, the y display pixel circuits 8 connected to the selected gate line are selected collectively.

The source driver circuit 6 drives the source lines SL1 to SLy. More specifically, based on the control signal CSs, the source driver circuit 6 applies potentials corresponding to the video signal VS to the source lines SL1 to SLy. Herein, the source driver circuit 6 may perform line sequential drive, or may perform dot sequential drive. The potentials applied to the source lines SL1 to SLy are written to the y display pixel circuits 8 selected by the gate driver circuit 5. As described above, it is possible to write the potentials corresponding to the video signal VS to all the display pixel circuits 8 by use of the gate driver circuit 5 and the source driver circuit 6, thereby displaying a desired image on the display panel 2.

The sensor row driver circuit 7 drives the clock lines CLK1 to CLKn, the reset lines RST1 to RSTn, the read lines RWS1 to RWSn, and the like. More specifically, based on the control signal CSr, the sensor row driver circuit 7 applies a HIGH-level potential to the clock lines CLK1 to CLKn when the backlight 3 is turned on, and applies a LOW-level potential to the clock lines CLK1 to CLKn when the backlight 3 is turned off. Moreover, based on the control signal CSr, the sensor row driver circuit 7 selects one reset line sequentially from among the reset lines RST1 to RSTn, applies a HIGH-level potential for reset to the selected reset line, and applies a LOW-level potential to the remaining reset lines. Thus, the (m/2) sensor pixel circuits 9 connected to the selected reset line are reset collectively.

Moreover, based on the control signal CSr, the sensor row driver circuit 7 selects one read line sequentially from among the read lines RWS1 to RWSn, applies a HIGH-level potential for read to the selected read line, and applies a LOW-level potential to the remaining read lines. Thus, the (m/2) sensor pixel circuits 9 connected to the selected read line turn to a readable state collectively. Herein, the source driver circuit 6 applies a HIGH-level potential to the power supply lines VDD1 to VDDm. Thus, the (m/2) sensor pixel circuits 9 in the readable state output signals corresponding to amounts of light sensed by the respective sensor pixel circuits 9 (hereinafter, referred to as sensor signals) to the output lines OUT1 to OUTm.

The source driver circuit 6 amplifies the sensor signals output to the output lines OUT1 to OUTm, and outputs the amplified signals sequentially as a sensor output Sout to the outside of the display panel 2. As described above, by reading the sensor signals from all the sensor pixel circuits 9 by use of the source driver circuit 6 and the sensor row driver circuit 7, it is possible to sense light incident on the display panel 2. The display device shown in FIG. 1 performs the following consecutive drive in order to sense light incident on the display panel 2.

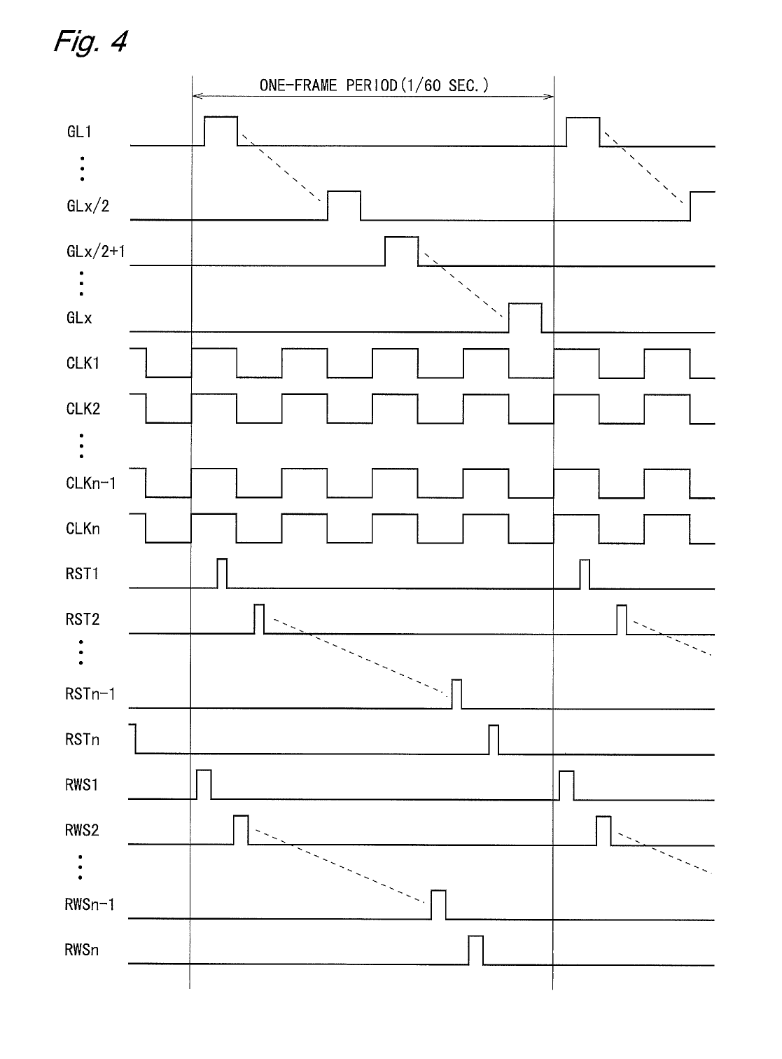

FIG. 3 is a diagram showing turn-on and turn-off timings of the backlight 3 as well as reset and read timings of the sensor pixel circuits 9. As shown in FIG. 3, the backlight 3 is turned on a plurality of times and is turned off a plurality of times in a one-frame period. It is assumed in the following description that the backlight 3 is turned on four times and is turned off four times in a one-frame period. A turn-on period is equal in length to a turn-off period. The reset for the sensor pixel circuits 9 is performed in a line sequential manner over a one-frame period (a solid line arrow). The read from the sensor pixel circuits 9 is performed after a lapse of almost the one-frame period from the reset (more specifically, after a lapse of a time which is slightly shorter than the one-frame period) (a broken line arrow).

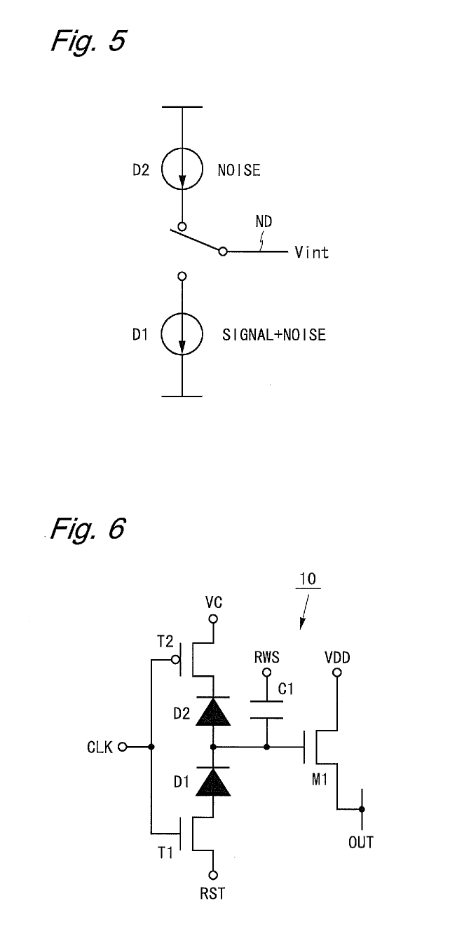

FIG. 4 is a signal waveform diagram of the display panel 2. As shown in FIG. 4, potentials at the gate lines GL1 to GLx sequentially turn to the HIGH level once for a predetermined time in a one-frame period. Potentials at the clock lines CLK1 to CLKn change at the same timing, and turn to the HIGH level and the LOW level four times, respectively, in the one-frame period. With regard to the potentials at the clock lines CLK1 to CLKn, the HIGH-level period is equal in length to the LOW-level period. Potentials at the reset lines RST1 to RSTn sequentially turn to the HIGH level once for a predetermined time in the one-frame period. Potentials at the read lines RWS1 to RWSn also sequentially turn to the HIGH level once for a predetermined time in the one-frame period. Immediately after the potential at the read line RWS1 changes from the HIGH level to the LOW level, the potential at the reset line RST1 changes from the LOW level to the HIGH level. Similar things hold true for the potentials at the reset lines RST2 to RSTn. Therefore, a period during which the sensor pixel circuit 9 senses light (a period from the reset to the read: AO shown in FIG. 3) becomes almost equal in length to the one-frame period.

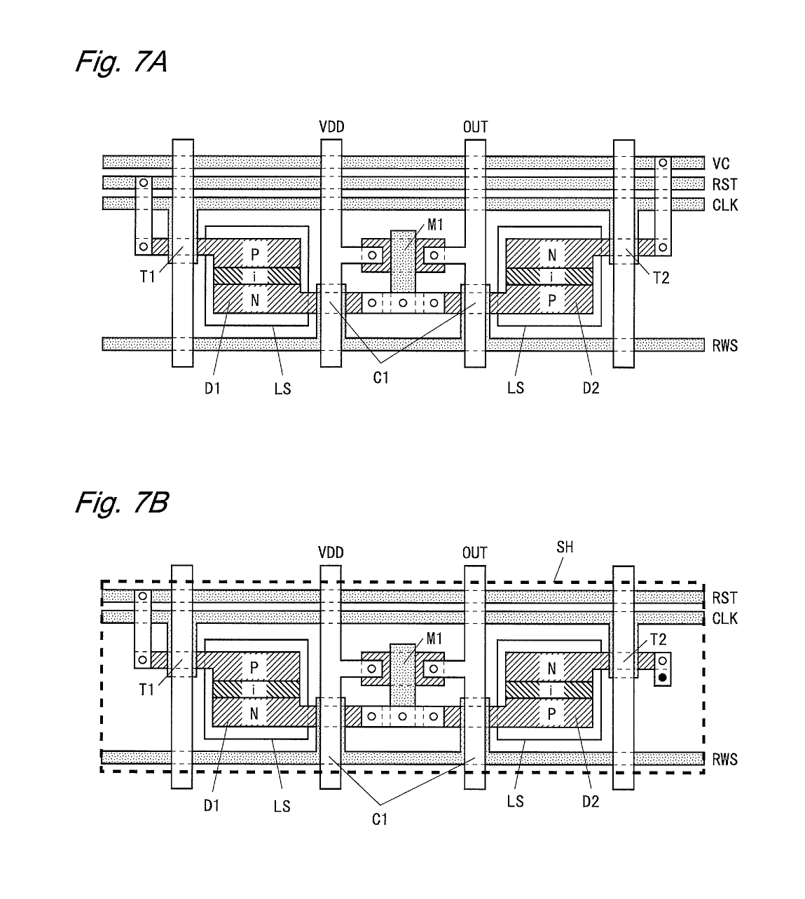

FIG. 5 is a diagram showing a schematic configuration of the sensor pixel circuit 9. As shown in FIG. 5, the sensor pixel circuit 9 includes two photodiodes D1 and D2, and one accumulation node ND. The photodiode D1 pulls out, of the accumulation node ND, charge corresponding to an amount of light to be incident while the backlight 3 is turned on. On the other hand, the photodiode D2 adds, to the accumulation node ND, charge corresponding to an amount of light to be incident while the backlight 3 is turned off. Therefore, a potential Vint at the accumulation node ND drops in accordance with the amount of light to be incident during a turn-on period of the backlight 3 (which corresponds to (signal+noise)), and rises in accordance with the amount of light to be incident during a turn-off period of the backlight 3 (which corresponds to noise). A sensor signal corresponding to a difference between the two types of amounts of light is read from the sensor pixel circuit 9.

It is to be noted that the number of sensor pixel circuits 9 to be provided in the pixel region 4 may be arbitrary. For example, the (n×m) sensor pixel circuits 9 may be provided in the pixel region 4. Alternatively, the sensor pixel circuits 9 the number of which is equal to that of color pixels (that is, (x×y/3)) may be provided in the pixel region 4. Alternatively, the sensor pixel circuits 9 the number of which is smaller than that of color pixels (for example, one severalth to one several tenth of color pixels) may be provided in the pixel region 4.

As described above, the display device according to the embodiment of the present invention is the display device in which the plurality of photodiodes (optical sensors) are arranged in the pixel region 4. The display device includes the display panel 2 that includes the plurality of display pixel circuits 8 and the plurality of sensor pixel circuits 9, and the sensor row driver circuit 7 (drive circuit) that outputs, to the sensor pixel circuit 9, the clock signals CLK1 to CLKn (control signals) each indicating that the backlight is turned on or the backlight is turned off. Hereinafter, description will be given of the details of the sensor pixel circuit 9 included in this display device. In the following description, a sensor pixel circuit is simply referred to as a pixel circuit, and a signal on a signal line is designated using the designation of the signal line for the sake of identification (for example, a signal on a clock line CLK is referred to as a clock signal CLK). The pixel circuit is connected to the clock line CLK, the reset line RST, the read line RWS, the power supply line VDD and the output line OUT, and is supplied with a potential VC. The potential VC is a potential which is higher than a HIGH-level potential for reset.

### First Embodiment

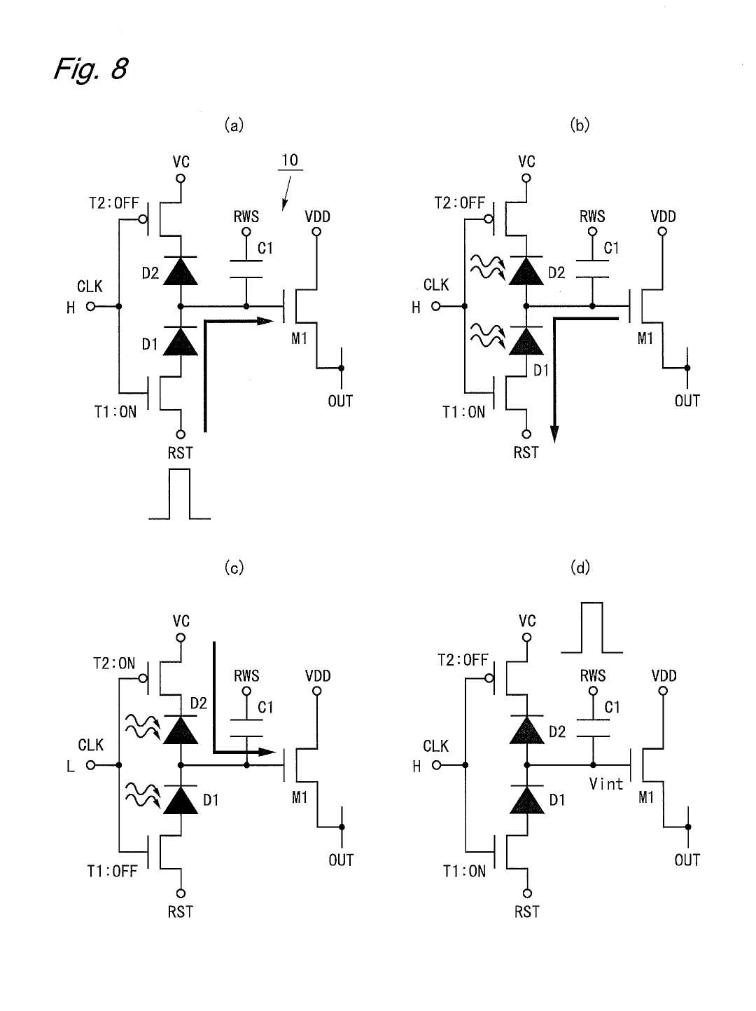

FIG. 6 is a circuit diagram of a pixel circuit according to a first embodiment of the present invention. A pixel circuit 10 shown in FIG. 6 includes transistors T1, T2 and M1, photodiodes D1 and D2, and a capacitor C1. Each of the transistors T1 and M1 is an N-type TFT (Thin Film Transistor), and the transistor T2 is a P-type TFT.

As shown in FIG. 6, gates of the transistors T1 and T2 are connected to a clock line CLK. In the transistor T1, a source is connected to a reset line RST, and a drain is connected to an anode of the photodiode D1. In the transistor T2, a source is applied with a potential VC, and a drain is connected to a cathode of the photodiode D2. A cathode of the photodiode D1 and an anode of the photodiode D2 are connected to a gate of the transistor M1. In the transistor M1, a drain is connected to a power supply line VDD, and a source is connected to an output line OUT. The capacitor C1 is provided between the gate of the transistor M1 and a read line RWS. In the pixel circuit 10, a node connected to the gate of the transistor M1 serves as an accumulation node that accumulates charge corresponding to an amount of sensed light, and the transistor M1 functions as a read transistor.

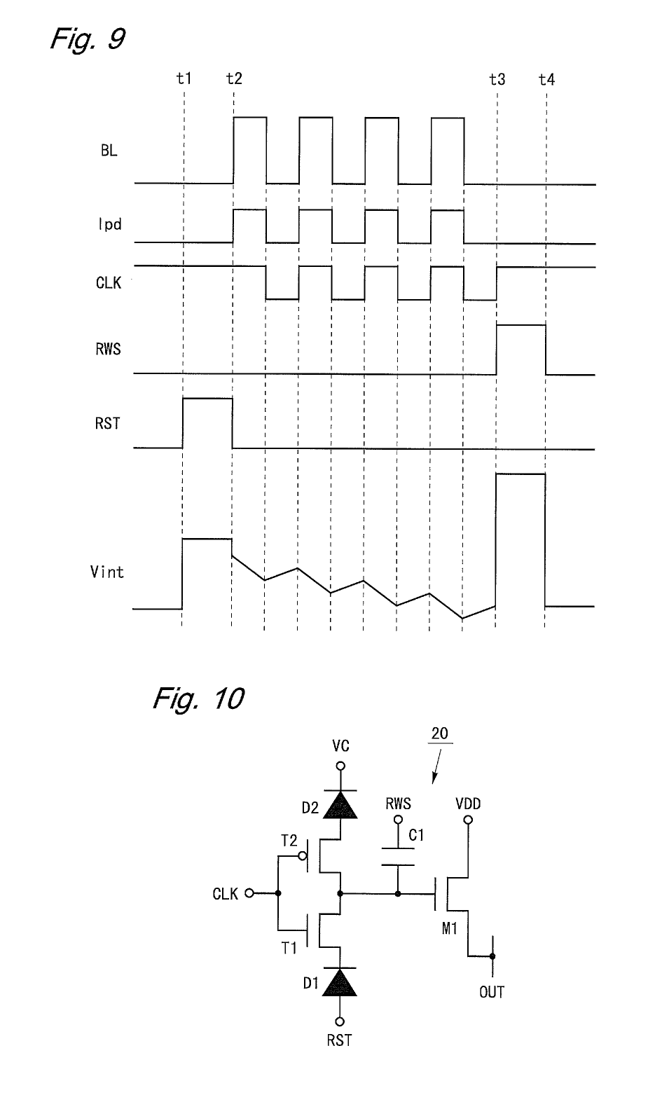

FIG. 7A is a layout diagram of the pixel circuit 10. As shown in FIG. 7A, the pixel circuit 10 has a configuration that a light shielding film LS, a semiconductor layer (hatch pattern portion), a gate wiring layer (dot pattern portion) and a source wiring layer (white portion) are formed sequentially on a glass substrate. A contact (shown with a white circle) is provided at a place where the semiconductor layer and the source wiring layer are connected, and a place where the gate wiring layer and the source wiring layer are connected. The transistors T1, T2 and M1 are formed by arranging the semiconductor layer and the gate wiring layer so that these two layers cross one another. The photodiodes D1 and D2 are formed by arranging a P layer, an I layer and an N layer included in the semiconductor layer so that these three layers are aligned. The capacitor C1 is formed by arranging the semiconductor layer and the gate wiring layer so that these two layers overlap. The light shielding film LS is made of metal, and prevents light entering through the back of the glass substrate from being incident on the photodiodes D1 and D2.

FIG. 7B is another layout diagram of the pixel circuit 10. According to the layout shown in FIG. 7B, the potential VC is applied to a shield SH (a transparent electrode: shown with a bold broken line) for covering a layout surface, and a contact (shown with a black circle) is provided at a place where the shield SH and the source wiring layer are connected. It is to be noted that the layout of the pixel circuits 10 may be changed in a form other than those described above.

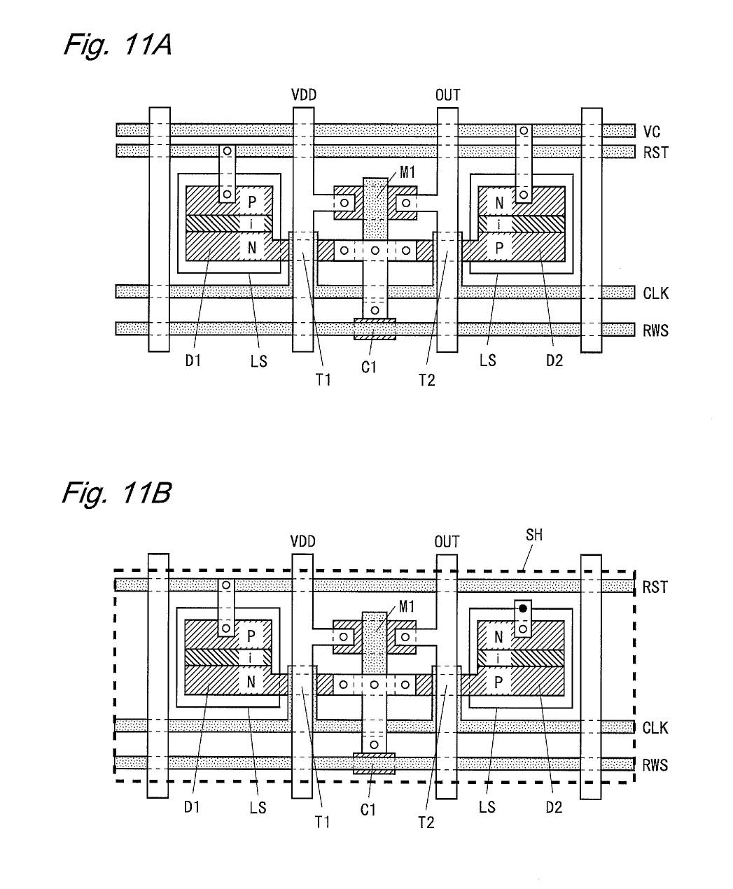

FIG. 8 is a diagram showing operations of the pixel circuit 10. As shown in FIG. 8, the pixel circuit 10 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period.

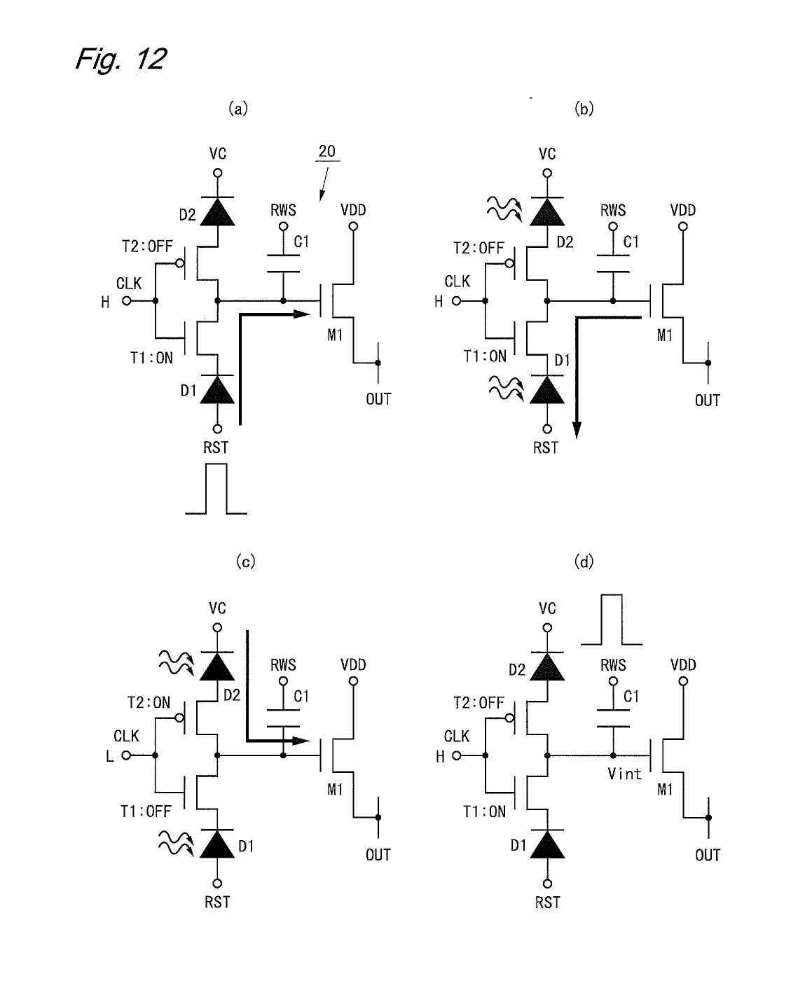

FIG. 9 is a signal waveform diagram of the pixel circuit 10. In FIG. 9, BL represents a brightness of the backlight 3, Ipd represents a current flowing through the photodiode, and Vint represents a potential at the accumulation node (a gate potential at the transistor M1). In FIG. 9, a reset period corresponds to a range from a time t1 to a time t2, an accumulation period corresponds to a range from the time t2 to a time t3, and a read period corresponds to a range from the time t3 to a time t4.

In the reset period, a clock signal CLK turns to a HIGH level, a read signal RWS turns to a LOW level, and a reset signal RST turns to a HIGH level for reset. Herein, the transistor T1 turns on, and the transistor T2 turns off. Accordingly, a current (a forward current in the photodiode D1) flows from the reset line RST into the accumulation node via the transistor T1 and the photodiode D1 (FIG. 8 (a)), and the potential Vint is reset to a predetermined level.

In the accumulation period, the reset signal RST and the read signal RWS turn to the LOW level, and the clock signal CLK turns to the HIGH level and the LOW level four times, respectively. While the clock signal CLK is in the HIGH level, the transistor T1 turns on, and the transistor T2 turns off. Herein, when light is incident on the photodiodes D1 and D2, a current (a photocurrent in the photodiode D1) flows from the accumulation node into the reset line RST via the photodiode D1 and the transistor T1, and charge is pulled out of the accumulation node (FIG. 8 (b)). Accordingly, the potential Vint drops in accordance with an amount of light to be incident while the clock signal CLK is in the HIGH level (a turn-on period of the backlight 3).

On the other hand, while the clock signal CLK is in the LOW level, the transistor T1 turns off, and the transistor T2 turns on. Herein, when light is incident on the photodiodes D1 and D2, a current (a photocurrent in the photodiode D2) flows from a wire having a potential VC into the accumulation node via the transistor T2 and the photodiode D2, and charge is added to the accumulation node (FIG. 8 (c)). Accordingly, the potential Vint rises in accordance with an amount of light to be incident while the clock signal CLK is in the LOW level (a turn-off period of the backlight 3).

In the read period, the clock signal CLK turns to the HIGH level, the reset signal RST turns to the LOW level, and the read signal RWS turns to a HIGH level for read. Herein, the transistor T1 turns on, and the transistor T2 turns off. Herein, the potential Vint rises by an amount which is (Cq/Cp) times (Cp: a capacitance value of the entire pixel circuit 10, Cq: a capacitance value of the capacitor C1) as large as a rise amount of a potential at the read signal RWS. The transistor M1 constitutes a source follower amplification circuit having, as a load circuit, a transistor (not shown) included in the source driver circuit 6, and drives the output line OUT in accordance with the potential Vint (FIG. 8 (d)).

As described above, the pixel circuit 10 according to this embodiment includes the two photodiodes D1 and D2 (first and second optical sensors), the one accumulation node which accumulates the charge corresponding to the amount of sensed light, the transistor M1 (read transistor) which has the gate connected to the accumulation node, the transistor T1 (first switching element) which is provided on the path for the current flowing through the photodiode D1 and turns on when the backlight is turned on, in accordance with the clock signal CLK, and the transistor T2 (second switching element) which is provided on the path for the current flowing through the photodiode D2 and turns on when the backlight is turned off, in accordance with the clock signal CLK. The photodiode D1 is provided between the accumulation node and one of the ends of the transistor T1, and the photodiode D2 is provided between the accumulation node and one of the ends of the transistor T2. The other end of the transistor T1 is connected to the reset line RST, and the other end of the transistor T2 is applied with the predetermined potential VC.

When the backlight is turned on, the transistor T1 turns on, and the potential at the accumulation node drops because of the current flowing through the photodiode D1. When the backlight is turned off, the transistor T2 turns on, and the potential at the accumulation node rises because of the current flowing through the photodiode D2. As described above, the potential at the accumulation node changes in reverse direction when the backlight is turned on and when the backlight is turned off. According to the pixel circuit 10, thus, it is possible to detect a difference between the amount of light when the backlight is turned on and the amount of light when the backlight is turned off, by use of one sensor pixel circuit, and to give an input function which does not depend on light environments.

Moreover, the difference between the amounts of light is detected by use of one sensor pixel circuit. Therefore, as compared with the case of detecting two types of amounts of light separately, it is possible to prevent the amount of light from being saturated and to correctly obtain the difference between the amounts of light. Moreover, as compared with the case of detecting two types of amounts of light sequentially by use of one sensor pixel circuit, it is possible to reduce a frequency of the read from the sensor pixel circuits, to retard the read speed, and to reduce power consumption in the device. Moreover, it becomes unnecessary to provide a memory which is required in the case of detecting two types of amounts of light sequentially and is used for storing the amount of light sensed firstly. Moreover, it is possible to increase the degree of freedom for setting the turn-on and turn-off timings of the backlight as well as the reset and read timings of the sensor pixel circuits. Moreover, the operation of sensing light when the backlight is turned on and the operation of sensing light when the backlight is turned off are performed a plurality of times, respectively, in the one-frame period. Therefore, it is possible to eliminate a deviation between the sensing period when the backlight is turned on and the sensing period when the backlight is turned off, and to prevent followability to motion input from varying in accordance with a direction of the input. Moreover, by obtaining the difference between the amounts of light by use of one sensor pixel circuit, it is possible to perform temperature compensation at the same time.

Moreover, the pixel circuit 10 further includes the capacitor C1 which is provided between the accumulation node and the read line RWS. Accordingly, it is possible to apply a HIGH-level potential for read to the read line RWS, thereby changing the potential at the accumulation node, and reading a signal corresponding to the amount of sensed light from the pixel circuit 10.

### Second Embodiment

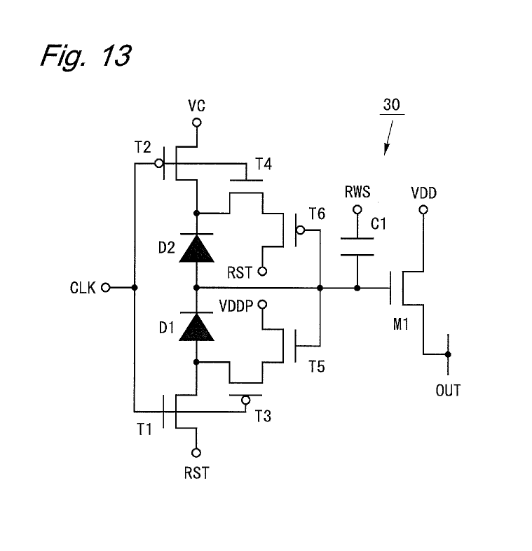

FIG. 10 is a circuit diagram of a pixel circuit according to a second embodiment of the present invention. A pixel circuit 20 shown in FIG. 10 includes transistors T1, T2 and M1, photodiodes D1 and D2, and a capacitor C1. Each of the transistors T1 and M1 is an N-type TFT, and the transistor T2 is a P-type TFT.

As shown in FIG. 10, gates of the transistors T1 and T2 are connected to a clock line CLK. In the photodiode D1, an anode is connected to a reset line RST, and a cathode is connected to a source of the transistor T1. In the photodiode D2, a cathode is applied with a potential VC, and an anode is connected to a source of the transistor T2. Drains of the transistors T1 and T2 are connected to a gate of the transistor M1. In the transistor M1, a drain is connected to a power supply line VDD, and a source is connected to an output line OUT. The capacitor C1 is provided between the gate of the transistor M1 and a read line RWS. In the pixel circuit 20, a node connected to the gate of the transistor M1 serves as an accumulation node, and the transistor M1 functions as a read transistor.

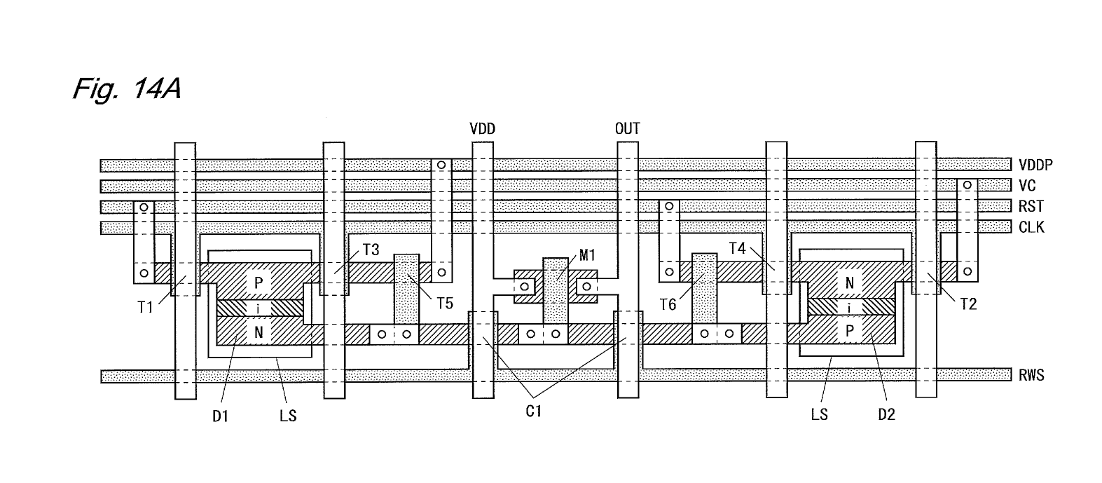

FIGS. 11A and 11B are layout diagrams of the pixel circuit 20. The description about these drawings is similar to that in the first embodiment. According to the layout shown in FIG. 11B, the potential VC is applied to a shield SH for covering a layout surface.

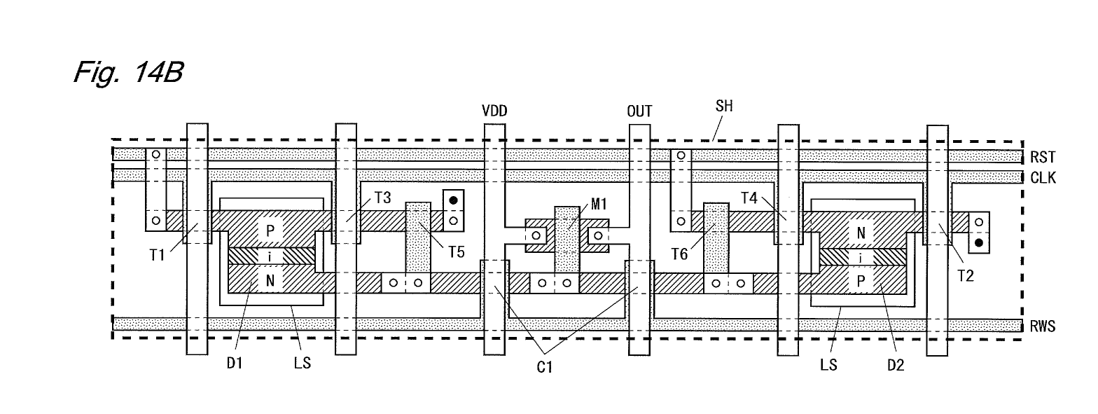

FIG. 12 is a diagram showing operations of the pixel circuit 20. As shown in FIG. 12, the pixel circuit 20 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period. A signal waveform diagram of the pixel circuit 20 is equal to that in the first embodiment (FIG. 9). The pixel circuit 20 operates as in the pixel circuit 10 according to the first embodiment.

As described above, as in the pixel circuit 10 according to the first embodiment, the pixel circuit 20 according to this embodiment includes the two photodiodes D1 and D2, the one accumulation node, the transistor M1, the transistor T1 which turns on when the backlight is turned on, and the transistor T2 which turns on when the backlight is turned off. The transistor T1 is provided between the accumulation node and one of the ends of the photodiode D1, and the transistor T2 is provided between the accumulation node and one of the ends of the photodiode D2. The other end of the photodiode D1 is connected to the reset line RST, and the other end of the photodiode D2 is applied with the predetermined potential VC.

When the backlight is turned on, the transistor T1 turns on, and a potential at the accumulation node drops because of a current flowing through the photodiode D1. When the backlight is turned off, the transistor T2 turns on, and the potential at the accumulation node rises because of a current flowing through the photodiode D2. As described above, the potential at the accumulation node changes in reverse direction when the backlight is turned on and when the backlight is turned off. According to the pixel circuit 20, it is possible to detect a difference between an amount of light when the backlight is turned on and an amount of light when the backlight is turned off, by use of one sensor pixel circuit, and to give an input function which does not depend on light environments. Thus, it is possible to attain effects which are similar to those in the first embodiment.

Moreover, in the case of changing the potential at the accumulation node to perform read, the photodiode D2 on the side of the transistor T2 which is in an OFF state is disconnected electrically from the accumulation node. Accordingly, it is possible to reduce a capacitance of the accumulation node at the time of read, and to readily change the potential at the accumulation node.

### Third Embodiment

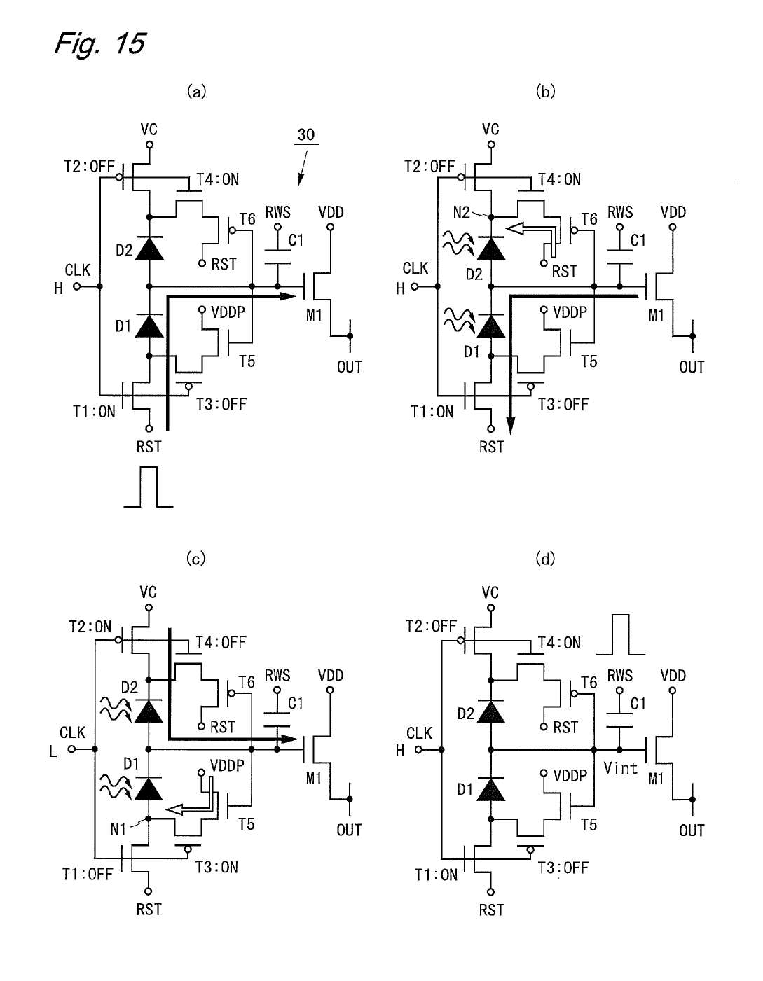

FIG. 13 is a circuit diagram of a pixel circuit according to a third embodiment of the present invention. A pixel circuit 30 shown in FIG. 13 includes transistors T1 to T6 and M1, photodiodes D1 and D2, and a capacitor C1. Each of the transistors T1, T4, T5 and M1 is an N-type TFT, and each of the transistors T2, T3 and T6 is a P-type TFT. In addition to a potential VC, a potential VDDP, which is higher than a HIGH-level potential for reset, is supplied to the pixel circuit 30. The potential VDDP may be a potential which is equal to the potential VC.

As shown in FIG. 13, gates of the transistors T1 to T4 are connected to a clock line CLK. In the transistor T1, a source is connected to a reset line RST, and a drain is connected to an anode of the photodiode D1 and a drain of the transistor T3. In the transistor T2, a source is applied with the potential VC, and a drain is connected to a cathode of the photodiode D2 and a drain of the transistor T4. A cathode of the photodiode D1 and an anode of the photodiode D2 are connected to a gate of the transistor M1. In the transistor M1, a drain is connected to a power supply line VDD, and a source is connected to an output line OUT. The capacitor C1 is provided between the gate of the transistor M1 and a read line RWS. Gates of the transistors T5 and T6 are connected to the gate of the transistor M1. In the transistor T5, a drain is applied with the potential VDDP, and a source is connected to a source of the transistor T3. In the transistor T6, a drain is connected to a reset line RST, and a source is connected to a source of the transistor T4. In the pixel circuit 30, a node connected to the gate of the transistor M1 serves as an accumulation node, and the transistor M1 functions as a read transistor.

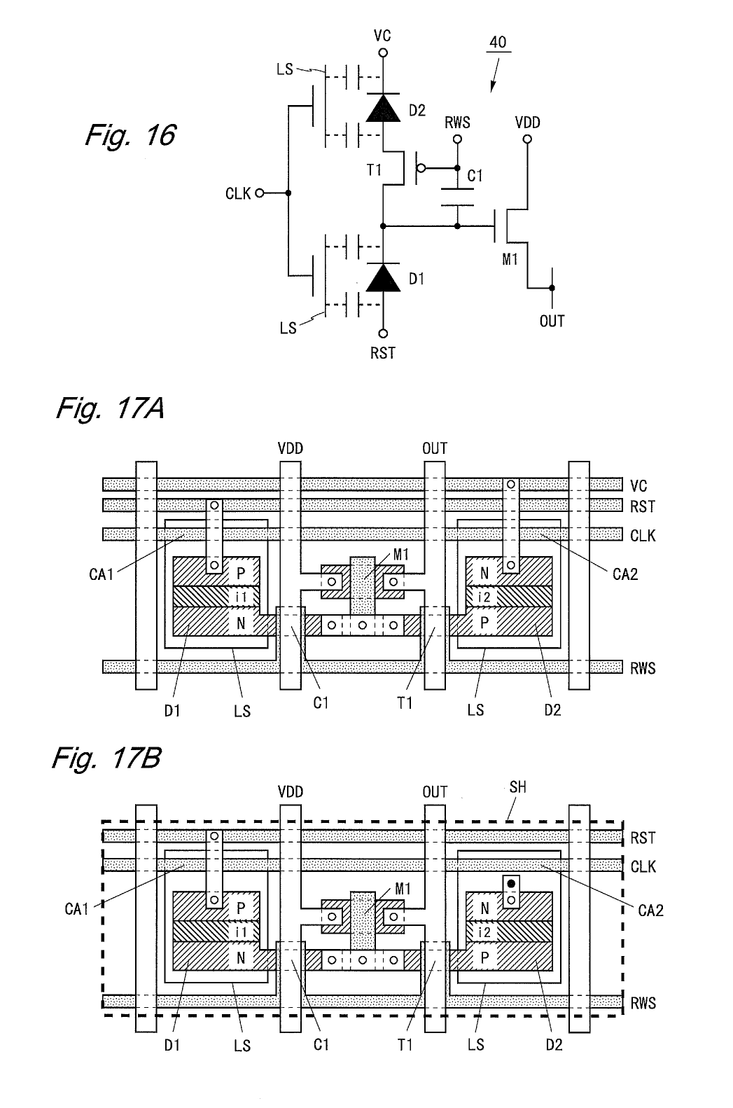

FIGS. 14A and 14B are layout diagrams of the pixel circuit 30. The description about these drawings is similar to that in the first embodiment. The layout shown in FIG. 14B is used in the case where the potential VC is applied as the potential VDDP. According to the layout shown in FIG. 14B, the potential VC (=VDDP) is applied to a shield SH for covering a layout surface.

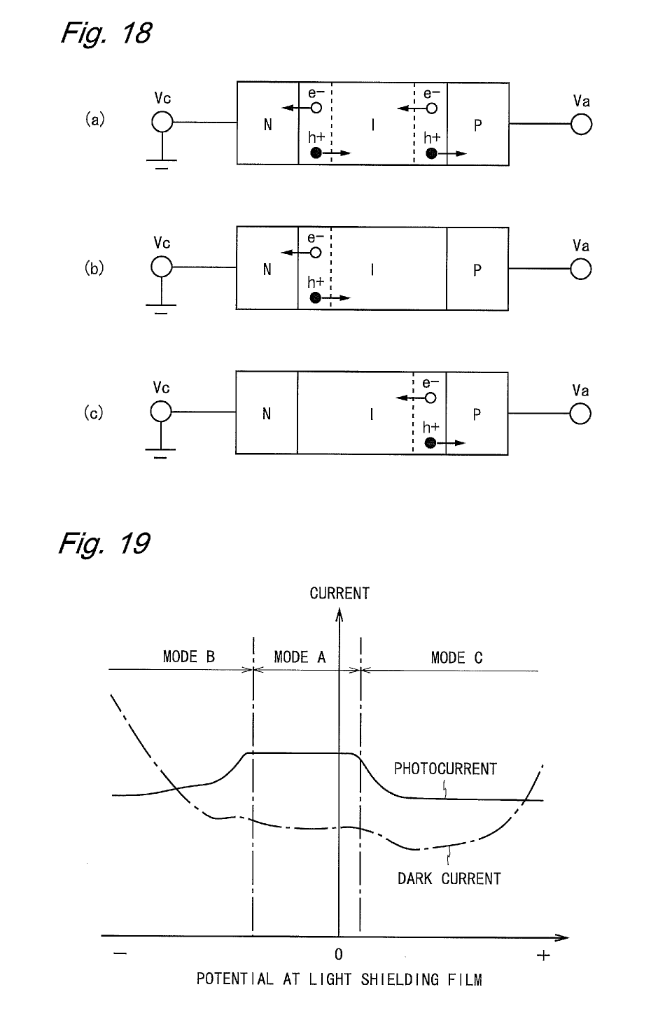

FIG. 15 is a diagram showing operations of the pixel circuit 30. As shown in FIG. 15, the pixel circuit 30 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period. A signal waveform diagram of the pixel circuit 30 is equal to that in the first embodiment (FIG. 9).

The pixel circuit 30 operates as in the pixel circuit 10 according to the first embodiment, except for the following points. The transistor T3 turns on or off as in the transistor T2, and the transistor T4 turns on or off as in the transistor T1. In an accumulation period, when a clock signal CLK changes from a LOW level to a HIGH level, the transistor T4 changes off to on. At this moment, a node N2 connected to the cathode of the photodiode D2 is charged with a potential corresponding to a gate potential Vint at the transistor M1, via the transistors T4 and T6 (a white arrow in FIG. 15 (b)). Therefore, a current flowing through the photodiode D2 is interrupted immediately when the clock signal CLK changes from the LOW level to the HIGH level.

On the other hand, in the accumulation period, when the clock signal CLK changes from the HIGH level to the LOW level, the transistor T3 changes off to on. At this moment, a node N1 connected to the anode of the photodiode D1 is charged with the potential corresponding to the gate potential Vint at the transistor M1, via the transistors T3 and T5 (a white arrow in FIG. 15 (c)). Therefore, a current flowing through the photodiode D1 is interrupted immediately when the clock signal CLK changes from the HIGH level to the LOW level.

As described above, the pixel circuit 30 according to this embodiment corresponds to the pixel circuit 10 according to the first embodiment additionally including the transistor T3 (third switching element) which has one of the ends connected to the transistor T1-side terminal of the photodiode D1 and turns on when the backlight is turned off, in accordance with the clock signal CLK, the transistor T4 (fourth switching element) which has one of the ends connected to the transistor T2-side terminal of the photodiode D2 and turns on when the backlight is turned on, in accordance with the clock signal CLK, the transistor T5 (fifth switching element) which feeds the potential corresponding to the potential at the accumulation node to the other end of the transistor T3, and the transistor T6 (sixth switching element) which feeds the potential corresponding to the potential at the accumulation node to the other end of the transistor T4.

According to the pixel circuit 30, in addition to the effects of the pixel circuit 10 according to the first embodiment, by applying potentials corresponding to potentials at the accumulation nodes to the terminals, which are opposed to the accumulation nodes, of the photodiodes D1 and D2 upon change of the clock signal CLK, it is possible to immediately interrupt currents flowing through the photodiodes D1 and D2, and to enhance detection accuracy.

### Fourth Embodiment

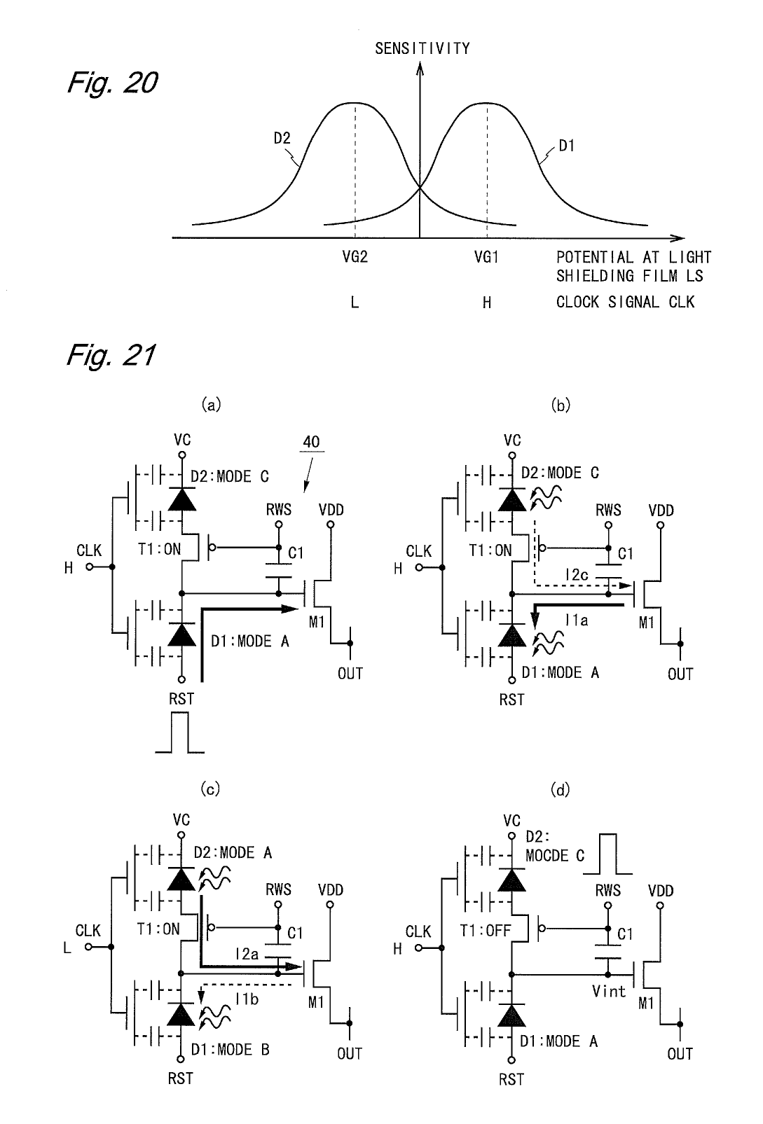

FIG. 16 is a circuit diagram of a pixel circuit according to a fourth embodiment of the present invention. A pixel circuit 40 shown in FIG. 16 includes transistors T1 and M1, photodiodes D1 and D2, and a capacitor C1. The transistor T1 is a P-type TFT, and the transistor M1 is an N-type TFT.

As shown in FIG. 16, an anode of the photodiode D1 is connected to a reset line RST. In the photodiode D2, a cathode is applied with a potential VC, and an anode is connected to a source of the transistor T1. A cathode of the photodiode D1 and a drain of the transistor T1 are connected to a gate of the transistor M1. In the transistor M1, a drain is connected to a power supply line VDD, and a source is connected to an output line OUT. The capacitor C1 is provided between the gate of the transistor M1 and a read line RWS. A gate of the transistor T1 is connected to the read line RWS. In the pixel circuit 40, a node connected to the gate of the transistor M1 serves as an accumulation node, and the transistor M1 functions as a read transistor. A clock line CLK and a light shielding film LS will be described later.

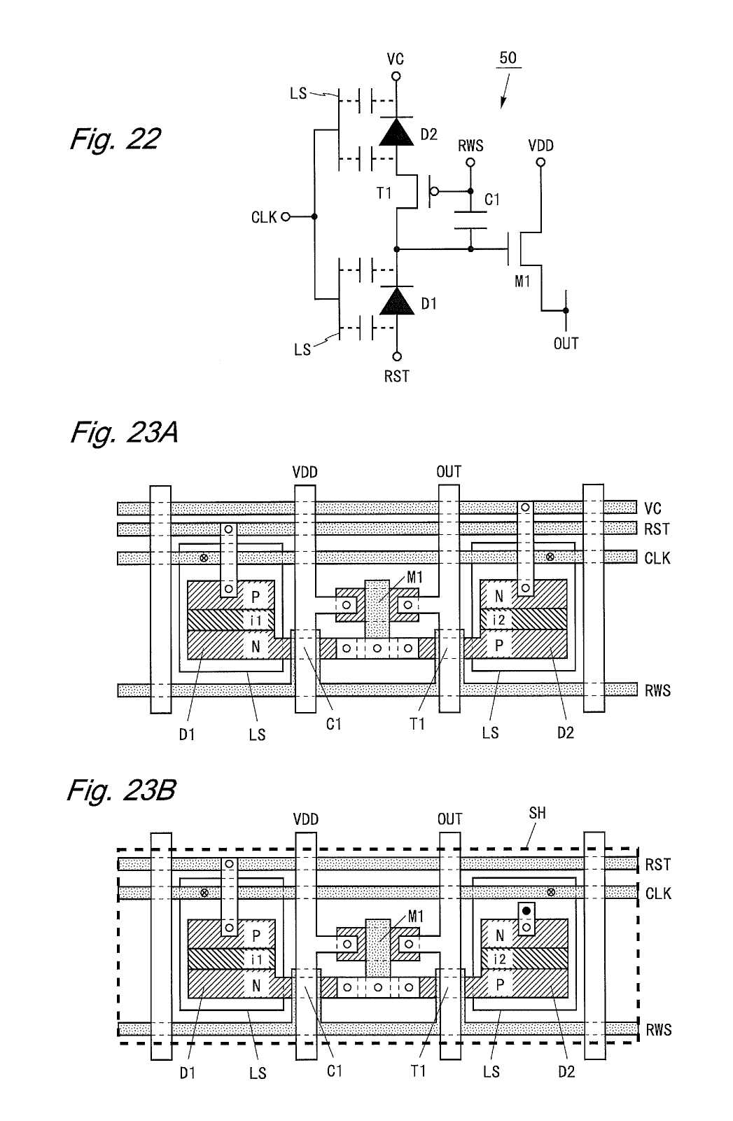

FIGS. 17A and 17B are layout diagrams of the pixel circuit 40. The description about these drawings is similar to that in the first embodiment, except for the following points. The clock line CLK is arranged to cross the light shielding films LS of the photodiodes D1 and D2. A capacitor CA1 is formed at a position where the clock line CLK crosses the light shielding film LS of the photodiode D1, and a capacitor CA2 is formed at a position where the clock line CLK crosses the light shielding film LS of the photodiode D2. As described above, the light shielding films LS of the photodiodes D1 and D2 are coupled to the clock line CLK via the capacitors CA1 and CA2, respectively. According to the layout shown in FIG. 17B, the potential VC is applied to a shield SH for covering a layout surface.

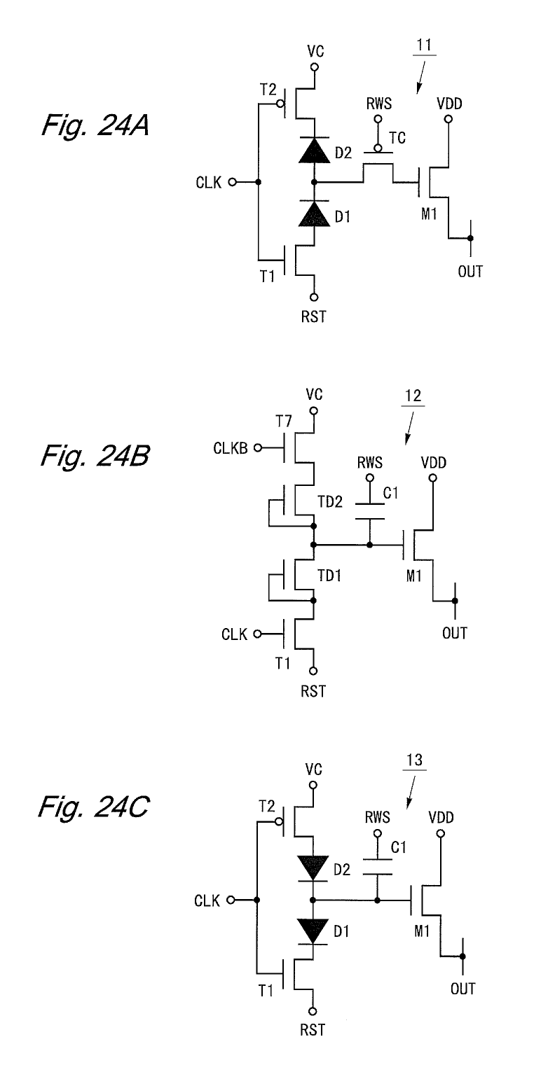

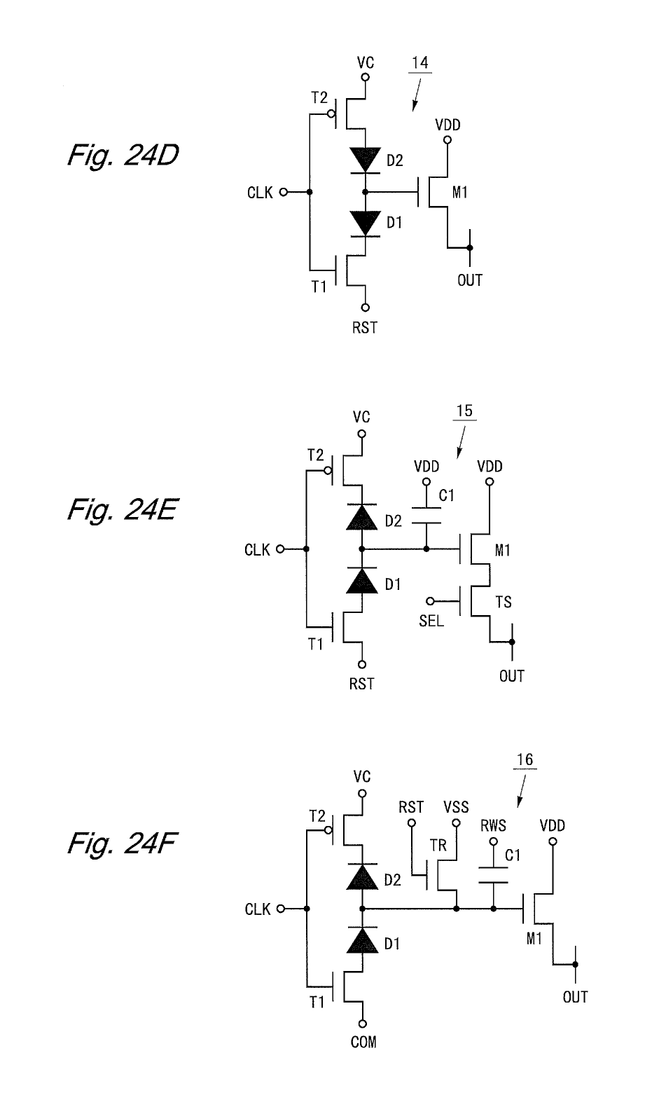

In general, the sensitivity of a photodiode varies in accordance with a potential at a light shielding film formed on a lower layer of the photodiode. With reference to FIGS. 18 and 19, hereinafter, description will be given of this matter. FIG. 18 is a diagram showing a situation that a state of a photodiode changes in accordance with a potential at a light shielding film. As shown in FIG. 18, in the case of a photodiode including a P layer, an I layer and an N layer, Va represents an anode potential, Vc represents a cathode potential, and Vg represents a potential at a light shielding film (not shown). Moreover, Vth_p represents a threshold voltage of an imaginary P-type MOS transistor in which a P layer serves as a source/drain region, a light shielding film serves as a gate electrode, and an insulating film (not shown) formed between a semiconductor layer and the light shielding film serves as a gate insulating film, and Vth_n represents a threshold voltage of an imaginary N-type MOS transistor in which an N layer serves as a source/drain region, a light shielding film serves as a gate electrode, and the above-mentioned insulating film serves as a gate insulating film.

The state of the photodiode changes based on whether the potential Vg of the light shielding film satisfies any of Expressions (1) to (3) described below. Hereinafter, the case where the potential Vg satisfies Expression (1) is referred to as a mode A, the case where the potential Vg satisfies Expression (2) is referred to as a mode B, and the case where the potential Vg satisfies Expression (3) is referred to as a mode C.

(Va+Vth_{—}p)<Vg<(Vc+Vth₁₃ n) (1)

Vg<(Va+Vth_{—}p)<(Vc+Vth_{—}n) (2)

(Va+Vth_{—}p)<(Vc+Vth_{—}n)<Vg (3)

In the mode A, free electrons and positive holes are apt to move in the proximity of two interfaces of the I layer (FIG. 18 (a)). Therefore, in the mode A, a current flows smoothly through the photodiode. In contrast to this, in the mode B, free electrons and positive holes are apt to move in the proximity of only the N layer-side interface of the I layer (FIG. 18 (b)). In the mode C, free electrons and positive holes are apt to move in the proximity of only the P layer-side interface of the I layer (FIG. 18 (c)). Therefore, in the mode B and the mode C, the flow of current is interrupted by the I layer.

FIG. 19 is a diagram showing a relation between a potential at the light shielding film and currents flowing through the photodiode. In FIG. 19, a horizontal axis denotes the potential at the light shielding film, and a vertical axis denotes the current flowing through the photodiode. As shown in FIG. 19, the photocurrent and dark current in the photodiode vary in accordance with the potential at the light shielding film. The photocurrent in the mode A becomes larger in amount than the photocurrents in the modes B and C.

As described above, the light shielding films LS of the photodiodes D1 and D2 included in the pixel circuit 40 are connected to the clock line CLK via the capacitors CA1 and CA2, respectively. Therefore, when the potential at the clock line CLK changes, the potentials at the light shielding films LS of the photodiodes D1 and D2 also change and, in association with this change, the sensitivities of the photodiodes D1 and D2 also change. Moreover, typically, in the case of forming a photodiode, it is possible to adjust the sensitivity of the photodiode by adjusting a doping amount in a semiconductor layer.

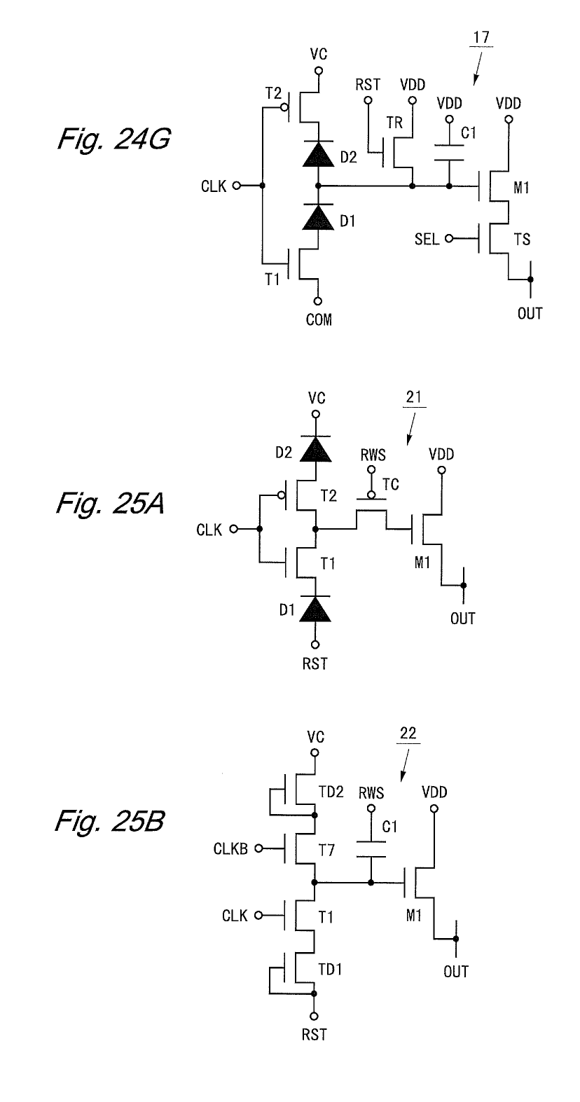

FIG. 20 is a diagram showing sensitivity characteristics of the photodiodes D1 and D2. As shown in FIG. 20, the photodiodes D1 and D2 are configured to have different sensitivity characteristics by adjustment of doping amounts in the semiconductor layers. More specifically, in the case where VG1 represents a potential at the light shielding film LS when the clock signal CLK is in a HIGH level and VG2 represents a potential at the light shielding film LS when the clock signal CLK is in a LOW level, the photodiodes D1 and D2 are configured so that the sensitivity of the photodiode D1 becomes higher than that of the photodiode D2 when the potential at the light shielding film LS is VG1 and the sensitivity of the photodiode D1 becomes lower than that of the photodiode D2 when the potential at the light shielding film LS is VG2. Hereinafter, it is assumed that when the potential at the light shielding film LS is almost VG1, the photodiode D1 operates in the mode A and the photodiode D2 operates in the mode C, and when the potential at the light shielding film LS is almost VG2, the photodiode D1 operates in the mode B and the photodiode D2 operates in the mode A.

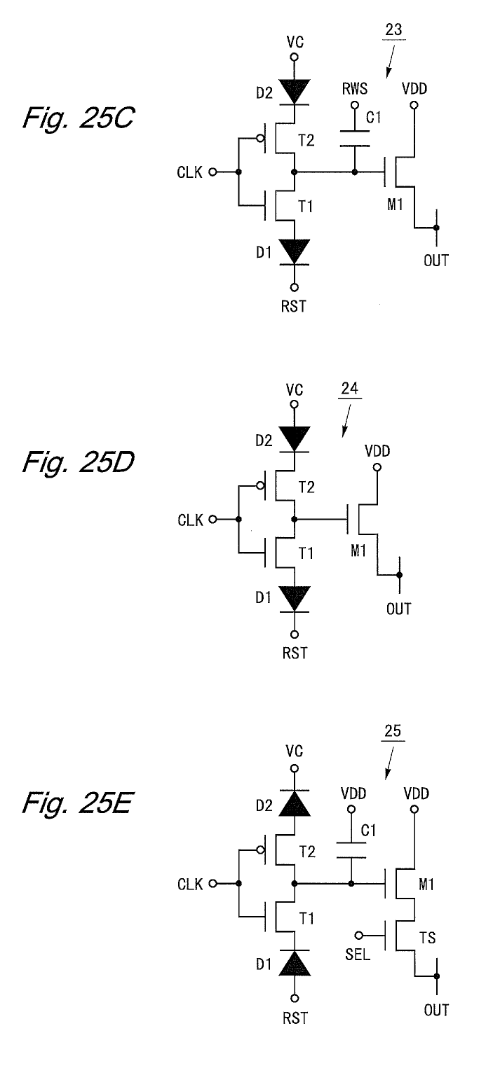

FIG. 21 is a diagram showing operations of the pixel circuit 40. As shown in FIG. 21, the pixel circuit 40 performs (a) reset, (b) accumulation when a backlight is turned on, (c) accumulation when the backlight is turned off, and (d) read, in a one-frame period. The accumulation when the backlight is turned on and the accumulation when the backlight is turned off are performed four times, respectively, in the one-frame period. A signal waveform diagram of the pixel circuit 40 is equal to that in the first embodiment (FIG. 9).

In a reset period, a clock signal CLK turns to a HIGH level, a read signal RWS turns to a LOW level, and a reset signal RST turns to a HIGH level for reset. Herein, the transistor T1 turns on. Moreover, a current (a forward current in the photodiode D1) flows from the reset line RST into the accumulation node via the photodiode D1 (FIG. 21 (a)), and a potential Vint is reset to a predetermined level.

In an accumulation period, the reset signal RST and the read signal RWS turn to the LOW level, and the clock signal CLK turns to the HIGH level and the LOW level four times, respectively. Herein, the transistor T1 turns on. While the clock signal CLK is in the HIGH level, the photodiode D1 operates in the mode A, and the photodiode D2 operates in the mode C. Herein, when light is incident on the photodiodes D1 and D2, a current I1a (a photocurrent upon operation in the mode A) flows from the accumulation node into the reset line RST via the photodiode D1, and charge is pulled out of the accumulation node. In association with this, a current I2c (a photocurrent upon operation in the mode C) flows from a wire having the potential VC into the accumulation node via the photodiode D2 and the transistor T1, and charge is added to the accumulation node (FIG. 21 (b)). Since the relation of I1a>I2c is satisfied, the potential Vint drops in accordance with an amount of light to be incident while the clock signal CLK is in the HIGH level (a turn-on period of the backlight 3).

On the other hand, while the clock signal CLK is in the LOW level, the photodiode D1 operates in the mode B, and the photodiode D2 operates in the mode A. Herein, when light is incident on the photodiodes D1 and D2, a current I1b (a photocurrent upon operation in the mode B) flows from the accumulation node into the reset line RST via the photodiode D1, and charge is pulled out of the accumulation node. In association with this, a current I2a (a photocurrent upon operation in the mode A) flows from the wire having the potential VC into the accumulation node via the photodiode D2 and the transistor T1, and charge is added to the accumulation node (FIG. 21 (c)). Since the relation of I1b<I2a is satisfied, the potential Vint rises in accordance with an amount of light to be incident while the clock signal CLK is in the LOW level (a turn-off period of the backlight 3).

In a read period, the clock signal CLK turns to the HIGH level, the reset signal RST turns to the LOW level, and the read signal RWS turns to a HIGH level for read. Herein, the transistor T1 turns off. Herein, the potential Vint rises by an amount which is (Cq/Cp) times (Cp: a capacitance value of the entire pixel circuit 40, Cq: a capacitance value of the capacitor C1) as large as a rise amount of a potential at the read signal RWS. The transistor M1 constitutes a source follower amplification circuit, and drives the output line OUT in accordance with the potential Vint (FIG. 21 (d)).

In the case where Ion represents a photocurrent when the clock signal CLK is in the HIGH level, Ioff represents a photocurrent when the clock signal CLK is in the LOW level, Ix represents a photocurrent based on light from the backlight, and Iy represents a photocurrent based on external light, Expression (4) described below is established when the clock signal CLK is in the HIGH level, and Expression (5) described below is established when the clock signal CLK is in the LOW level. Moreover, Expression (6) described below is established with regard to the photodiode D1 when the clock signal CLK is in the HIGH level, and Expression (7) described below is established with regard to the photodiode D2 when the clock signal CLK is in the LOW level.

Ion=I1a−I2c (4)

Ioff=I2a−I1b (5)

I1a=Ix+Iy (6)

I2a=Iy (7)

Herein, with regard to the photodiodes D1 and D2, in the case where the sensitivity in the mode B is equal to the sensitivity in the mode C and the sensitivity in the mode A is seven times as large as the sensitivities in the modes B and C, Expression (8) described below is derived from the relations of I2c=(1/7)×I1a and I1b=(1/7)×I2a.

$$\begin{matrix}Ion Ioff = ( 6 \text{/} 7 ) \times I 1 a - ( 6 \text{/} 7 ) \times I 2 a \\ = ( 6 \text{/} 7 ) \times ( Ix + Iy ) - ( 6 \text{/} 7 ) \times Iy \\ = ( 6 \text{/} 7 ) \times Ix\end{matrix} \qquad ( 8 )$$

As described above, the difference (Ion−Ioff) between the photocurrent when the clock signal CLK is in the HIGH level and the photocurrent when the clock signal CLK is in the LOW level does not contain the photocurrent Iy based on the external light. Accordingly, it is possible to correctly detect only the photocurrent based on light from the backlight by obtaining the difference (Ion−Ioff) between the photocurrents.

As described above, the pixel circuit 40 according to this embodiment includes the photodiodes D1 and D2 (first and second optical sensors), the one accumulation node which accumulates the charge corresponding to the amount of sensed light, and the transistor M1 (read transistor) which has the gate connected to the accumulation node. The clock line CLK (control line) for propagating the clock signal CLK is connected to the light shielding films LS formed on the photodiodes D1 and D2 via the capacitors. The sensitivity characteristics of the photodiodes D1 and D2 change in different manners in accordance with the clock signal CLK, and the same clock signal CLK is fed to the photodiodes D1 and D2.

The light shielding films LS of the photodiodes D1 and D2 are connected to the clock line CLK via the capacitors. Thus, when the potential at the clock line CLK changes, the potentials at the light shielding films LS change, and the sensitivity characteristics of the photodiodes D1 and D2 change. Accordingly, the photodiodes D1 and D2 having the sensitivity characteristics shown in FIG. 20 are controlled using the same clock signal CLK. Thus, when the backlight is turned on, a current flowing through the photodiode D1 becomes larger in amount than a current flowing through the photodiode D2, and a potential at the accumulation node drops because of the current flowing through the photodiode D1. On the other hand, when the backlight is turned off, the current flowing through the photodiode D2 becomes larger in amount than the current flowing through the photodiode D1, and the potential at the accumulation node rises because of the current flowing through the photodiode D2. As described above, the potential at the accumulation node changes in reverse direction when the backlight is turned on and when the backlight is turned off. According to the pixel circuit 40, hence, it is possible to detect a difference between the amount of light when the backlight is turned on and the amount of light when the backlight is turned off, by use of one sensor pixel circuit, and to give an input function which does not depend on light environments. Thus, it is possible to attain effects which are similar to those in the first embodiment.

Moreover, the pixel circuit 40 includes the capacitor C1 which is provided between the accumulation node and the read line RWS, and the transistor T1 (switching element) which is provided between the accumulation node and one of the ends of the photodiode D2 and turns off when the HIGH-level potential for read is applied to the read line RWS. The photodiode D1 is provided between the accumulation node and the reset line RST, and the other end of the photodiode D2 is applied with the predetermined potential VC. Accordingly, the photodiodes D1 and D2 are connected electrically to the accumulation node every time during a sensing period. Therefore, it is possible to prevent errors due to left charge and to enhance detection accuracy. Moreover, there is attained an effect that it is unnecessary to provide contacts on the light shielding films LS of the photodiodes D1 and D2.

### Fifth Embodiment

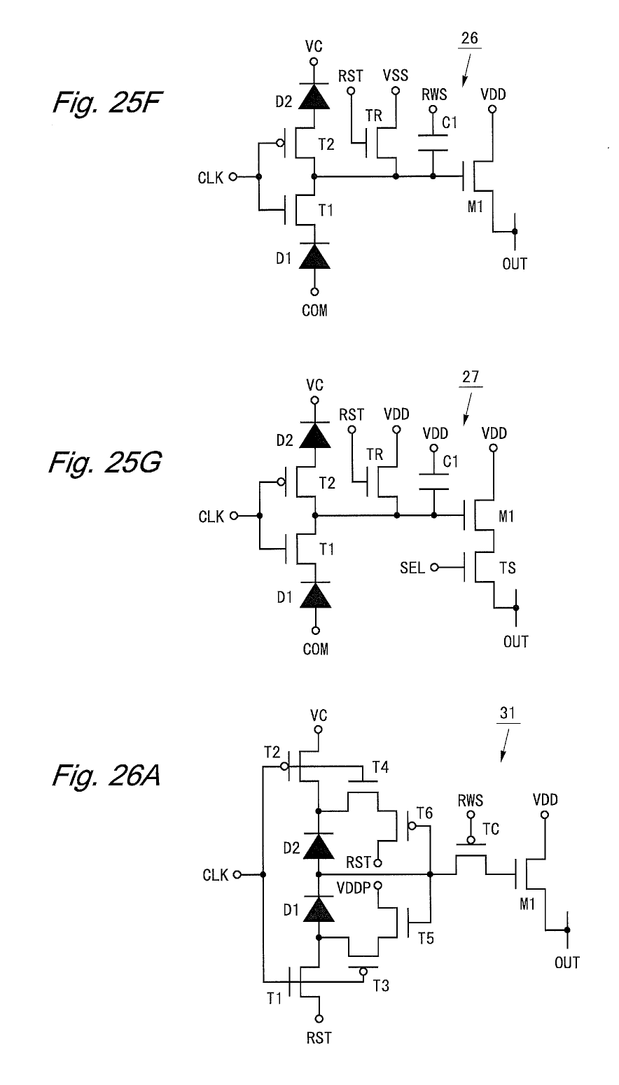

FIG. 22 is a circuit diagram of a pixel circuit according to a fifth embodiment of the present invention. A pixel circuit 50 shown in FIG. 22 includes transistors T1 and M1, photodiodes D1 and D2, and a capacitor C1. The transistor T1 is a P-type TFT, and the transistor M1 is an N-type TFT. The transistors T1 and M1, the photodiodes D1 and D2, and the capacitor C1 are connected in a form which is similar to that in the pixel circuit 40 according to the fourth embodiment.

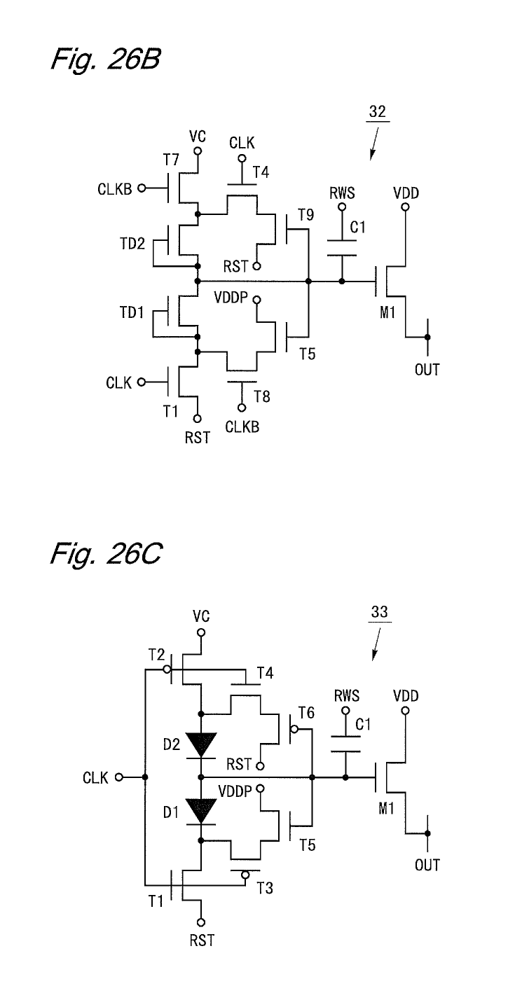

FIGS. 23A and 23B are layout diagrams of the pixel circuit 50. The description about these drawings is similar to that in the first embodiment, except for the following points. A clock line CLK is arranged to cross light shielding films LS of the photodiodes D1 and D2. A contact (shown with a circle having a cross placed therein) is provided at a place where the clock line CLK crosses the light shielding film LS of the photodiode D1 and a place where the clock line CLK crosses the light shielding film LS of the photodiode D2. As described above, the clock line CLK is connected electrically to the light shielding films LS of the photodiodes D1 and D2 via the contacts. According to the layout shown in FIG. 23B, the potential VC is applied to a shield SH for covering a layout surface.

As in the fourth embodiment, the photodiodes D1 and D2 are configured to have different sensitivity characteristics by adjustment of doping amounts in semiconductor layers (FIG. 20). A signal waveform diagram of the pixel circuit 50 is equal to that in the first embodiment (FIG. 9). The pixel circuit 50 operates as in the pixel circuit 40 according to the fourth embodiment (FIG. 21).

As described above, as in the pixel circuit 40 according to the fourth embodiment, the pixel circuit 50 according to this embodiment includes the two photodiodes D1 and D2, the one accumulation node, and the transistor M1. The clock line CLK (control line) for propagating the clock signal CLK is connected electrically to the light shielding films LS formed on the photodiodes D1 and D2. The sensitivity characteristics of the photodiodes D1 and D2 change in different manners in accordance with the clock signal CLK, and the same clock signal CLK is fed to the photodiodes D1 and D2.

The light shielding films LS of the photodiodes D1 and D2 are connected electrically to the clock line CLK. Thus, when a potential at the clock line CLK changes, potentials at the light shielding films LS change, and the sensitivity characteristics of the photodiodes D1 and D2 change. Accordingly, as in the pixel circuit 40 according to the fourth embodiment, by using the photodiodes D1 and D2 having the sensitivity characteristics shown in FIG. 20, a potential at the accumulation node changes in reverse direction when a backlight is turned on and when the backlight is turned off. According to the pixel circuit 50, hence, it is possible to detect a difference between an amount of light when the backlight is turned on and an amount of light when the backlight is turned off, by use of one sensor pixel circuit, and to give an input function which does not depend on light environments. Thus, it is possible to attain effects which are similar to those in the first embodiment.

Moreover, as in the pixel circuit 40 according to the fourth embodiment, it is possible to prevent errors due to left charge and to enhance detection accuracy. Moreover, as compared with the pixel circuit 40 according to the fourth embodiment, when the potential at the clock line CLK changes, the potentials at the light shielding film LS change largely, and the sensitivities of the photodiodes D1 and D2 change largely. Accordingly, even in the case of using a clock signal CLK which is small in amplitude, it is possible to change the sensitivities of the photodiodes D1 and D2 largely, and to detect the difference between the amount of light when the backlight is turned on and the amount of light when the backlight is turned off.

### Modification Examples of Embodiments

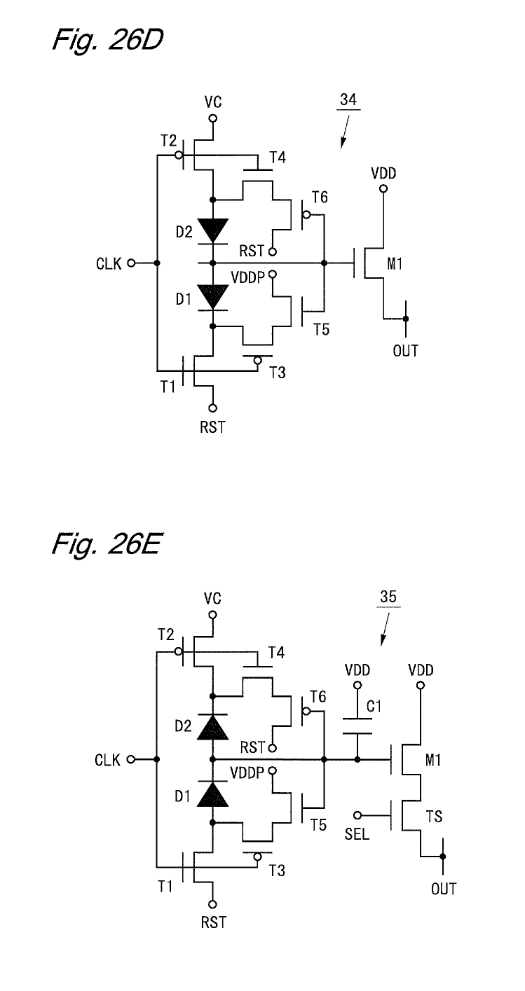

The respective embodiments of the present invention may employ the following modification examples. FIGS. 24A to 24G are circuit diagrams of pixel circuits according to first to seventh modification examples of the first embodiment. Pixel circuits 11 to 17 shown in FIGS. 24A to 24G are achieved in such a manner that the pixel circuit 10 according to the first embodiment is subjected to the following modifications.

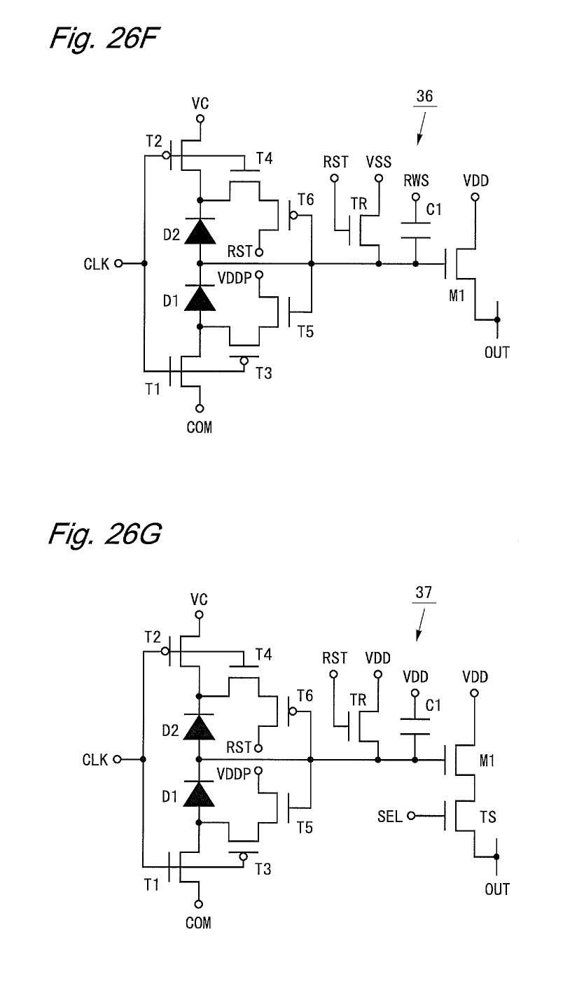

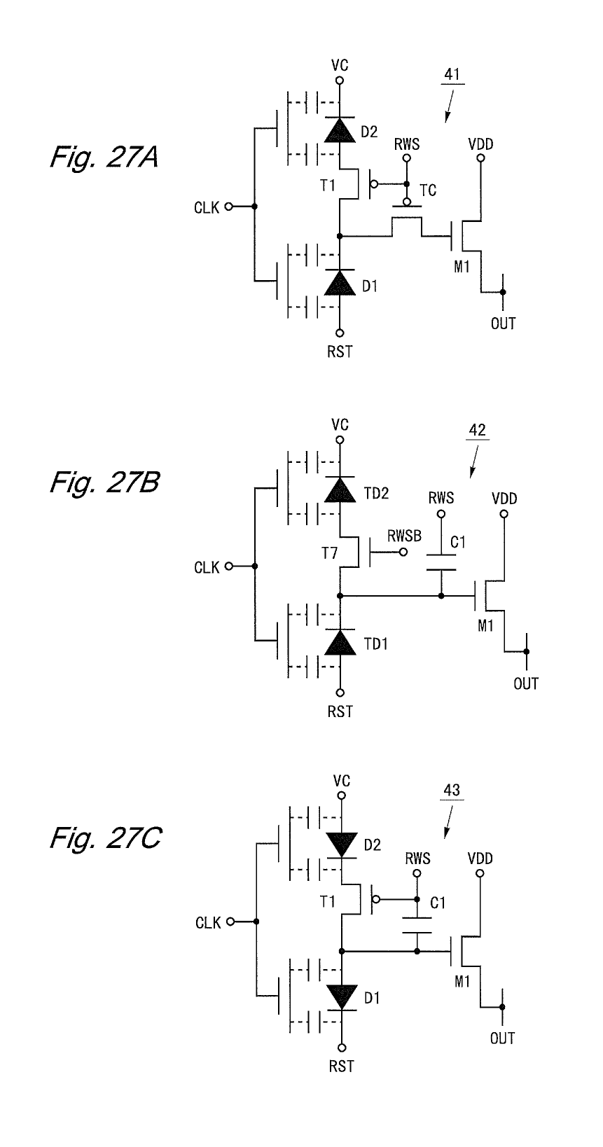

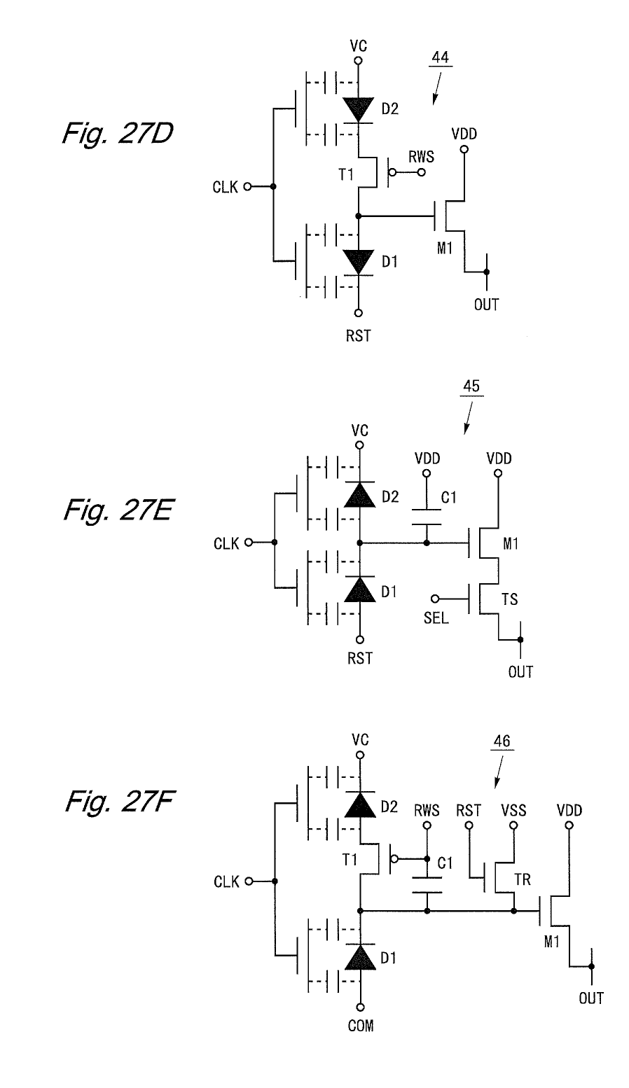

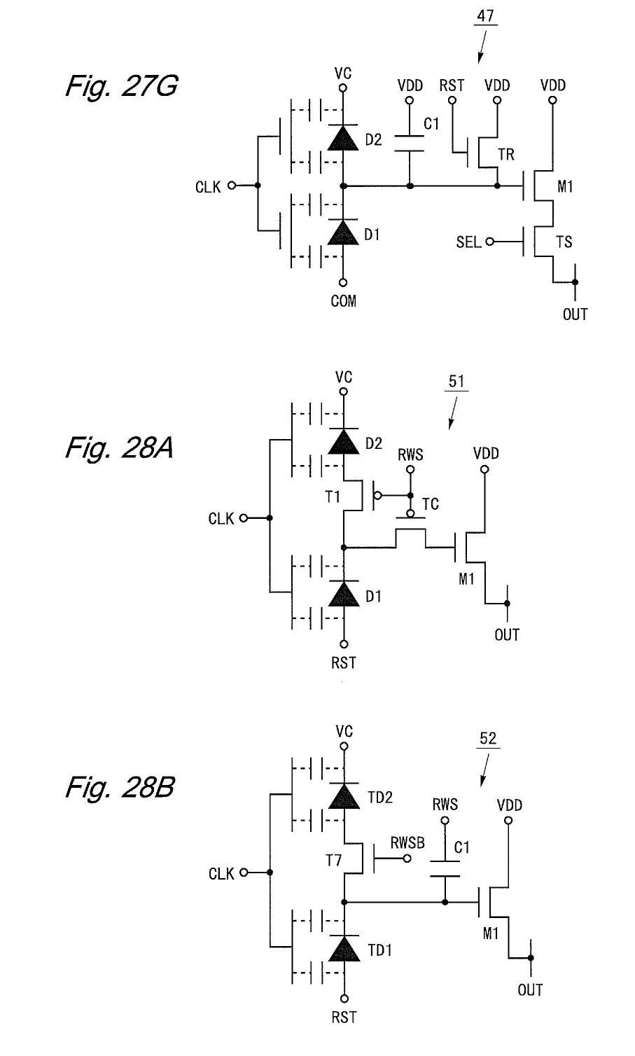

The pixel circuit 11 shown in FIG. 24A corresponds to the pixel circuit 10 in which the capacitor C1 is substituted with a transistor TC which is a P-type TFT. With regard to the pixel circuit 11, in the transistor TC, one of conductive terminals is connected to a cathode of a photodiode D1 and an anode of a photodiode D2, the other conductive terminal is connected to a gate of a transistor M1, and a gate is connected to a read line RWS. When a HIGH level for read is applied to the read line RWS, the transistor TC having the connection form described above causes a larger change in a potential at an accumulation node, as compared with the original pixel circuit. Accordingly, it is possible to amplify a difference between a potential at the accumulation node in the case where incident light is strong and a potential at the accumulation node in the case where incident light is weak, to improve the sensitivity of the pixel circuit 11. A pixel circuit 21 shown in FIG. 25A, a pixel circuit 31 shown in FIG. 26A, a pixel circuit 41 shown in FIG. 27A and a pixel circuit 51 shown in FIG. 28A are achieved in such a manner that similar modifications are carried out on the second to fifth embodiments.

The pixel circuit 12 shown in FIG. 24B corresponds to the pixel circuit 10 in which the photodiodes D1 and D2 are substituted with phototransistors TD1 and TD2 and the transistor T2 is substituted with a transistor T7 which is an N-type TFT. With regard to the pixel circuit 12, in the transistor T7, a drain is applied with a potential VC, a source is connected to a cathode of the phototransistor TD2, and a gate is connected to a clock line CLKB for propagating an inverted signal of a clock signal CLK. Thus, all the transistors included in the pixel circuit 12 are of an N-type. Accordingly, it is possible to manufacture the pixel circuit 12 by use of a single channel process capable of manufacturing only N-type transistors. A pixel circuit 22 shown in FIG. 25B, a pixel circuit 32 shown in FIG. 26B, a pixel circuit 42 shown in FIG. 27B and a pixel circuit 52 shown in FIG. 28B are achieved in such a manner that similar modifications are carried out on the second to fifth embodiments. It is to be noted that with regard to the pixel circuit 32 shown in FIG. 26B, all the P-type transistors T2, T3 and T6 included in the pixel circuit 30 need to be substituted with N-type transistors T7, T8 and T9.

The pixel circuit 13 shown in FIG. 24C corresponds to the pixel circuit 10 in which the photodiodes D1 and D2 are connected in reverse. The pixel circuit 13 is supplied with a reset signal RST which is in a HIGH level in a normal condition and turns to a LOW level for reset at the time of reset, and a LOW-level potential VC which is lower than a LOW-level potential for reset. A drain of a transistor T1 is connected to a reset line RST, and a source of the transistor T1 is connected to a cathode of the photodiode D1. In a transistor T2, a drain is applied with a potential VC, and a source is connected to an anode of the photodiode D2. An anode of the photodiode D1 and a cathode of the photodiode D2 are connected to a gate of a transistor M1. Thus, it is possible to achieve a variety of pixel circuits. A pixel circuit 23 shown in FIG. 25C, a pixel circuit 33 shown in FIG. 26C, a pixel circuit 43 shown in FIG. 27C and a pixel circuit 53 shown in FIG. 28C are achieved in such a manner that similar modifications are carried out on the second to fifth embodiments.

The pixel circuit 14 shown in FIG. 24D corresponds to the pixel circuit 10 in which the photodiodes D1 and D2 are connected in reverse and from which the capacitor C1 is removed. The pixel circuit 14 is supplied with a reset signal RST and a potential VC as in the pixel circuit 13. However, the reset signal RST turns to a HIGH level for read at the time of read. When the reset signal RST turns to the HIGH level for read, a potential at an accumulation node (a gate potential at a transistor M1) rises, and a current corresponding to a potential at the accumulation node flows into the transistor M1. As described above, the pixel circuit 14 does not include the capacitor C1. Accordingly, it is possible to increase an aperture ratio by virtue of the removal of the capacitor C1, and to improve the sensitivity of the pixel circuit. A pixel circuit 24 shown in FIG. 25D, a pixel circuit 34 shown in FIG. 26D, a pixel circuit 44 shown in FIG. 27D and a pixel circuit 54 shown in FIG. 28D are achieved in such a manner that similar modifications are carried out on the second to fifth embodiments.

The pixel circuit 15 shown in FIG. 24E corresponds to the pixel circuit 10 to which a transistor TS is added. The transistor TS is an N-type TFT, and functions as a switching element for selection. With regard to the pixel circuit 15, in a capacitor C1, one of electrodes is applied with a HIGH-level potential VDD. A source of a transistor M1 is connected to a drain of the transistor TS. In the transistor TS, a source is connected to an output line OUT, and a gate is connected to a selection line SEL. A selection signal SEL turns to a HIGH level at the time of read from the pixel circuit 15. Thus, it is possible to achieve a variety of pixel circuits. A pixel circuit 25 shown in FIG. 25E, a pixel circuit 35 shown in FIG. 26E, a pixel circuit 45 shown in FIG. 27E and a pixel circuit 55 shown in FIG. 28E are achieved in such a manner that similar modifications are carried out on the second to fifth embodiments. It is to be noted that the pixel circuits 45 and 55 shown in FIGS. 27E and 28E do not need to include the transistor T1.

The pixel circuit 16 shown in FIG. 24F corresponds to the pixel circuit 10 to which a transistor TR is added. The transistor TR is an N-type TFT, and functions as a switching element for reset. With regard to the pixel circuit 16, in the transistor TR, a source is applied with a LOW-level potential VSS, a drain is connected to a gate of a transistor M1, and a gate is connected to a reset line RST. Moreover, a source of the transistor T1 is applied with a LOW-level potential COM. Thus, it is possible to achieve a variety of pixel circuits. A pixel circuit 26 shown in FIG. 25F, a pixel circuit 36 shown in FIG. 26F, a pixel circuit 46 shown in FIG. 27F and a pixel circuit 56 shown in FIG. 28F are achieved in such a manner that similar modifications are carried out on the second to fifth embodiments.

The pixel circuit 17 shown in FIG. 24G corresponds to the pixel circuit 10 to which the transistors TS and TR described above are added. Connection forms of the transistors TS and TR are equal to those in the pixel circuits 15 and 16. However, with regard to the pixel circuit 17, the drain of the transistor TR is applied with a HIGH-level potential VDD. Thus, it is possible to achieve a variety of pixel circuits. A pixel circuit 27 shown in FIG. 25G, a pixel circuit 37 shown in FIG. 26G, a pixel circuit 47 shown in FIG. 27G and a pixel circuit 57 shown in FIG. 28G are achieved in such a manner that similar modifications are carried out on the second to fifth embodiments.

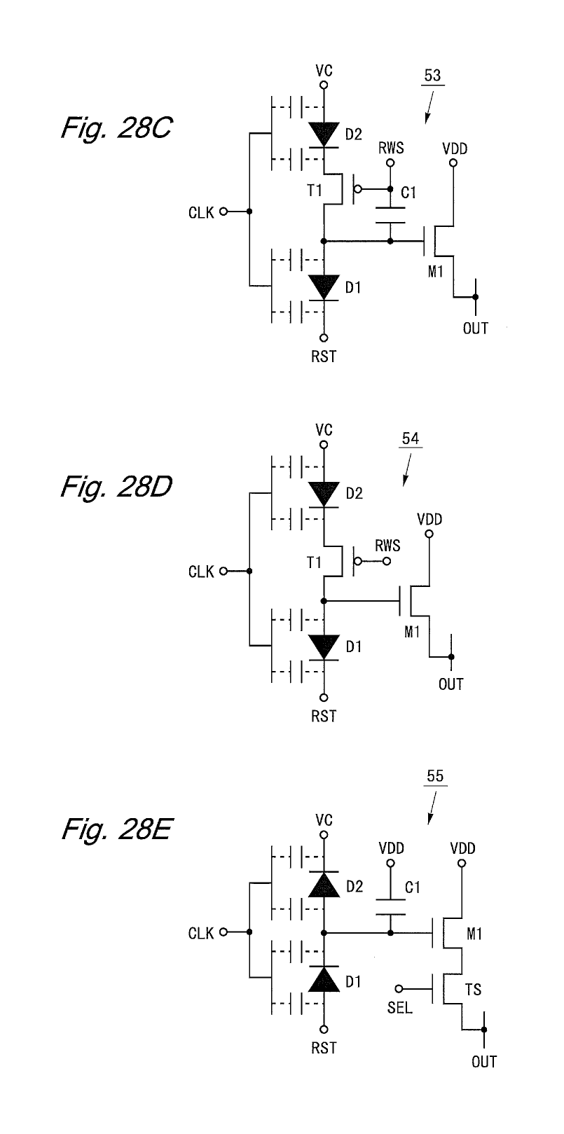

FIG. 29A is a circuit diagram of a pixel circuit according to an eighth modification example of the fourth embodiment. FIG. 29B is a circuit diagram of a pixel circuit according to an eighth modification example of the fifth embodiment. As shown in FIG. 29A and FIG. 29B, a pixel circuit 48 and a pixel circuit 58 are connected to a clock line CLKB for propagating an inverted signal of a clock signal CLK, in addition to a clock line CLK.

In the pixel circuits 48 and 58, the clock line CLK is arranged to cross a light shielding film of a photodiode D1, but not to cross a light shielding film of a photodiode D2. The clock line CLKB is arranged to cross the light shielding film of the photodiode D2, but not to cross the light shielding film of the photodiode D1. Moreover, in the pixel circuit 58, the clock line CLK is connected electrically to the light shielding film of the photodiode D1 via a contact. The clock line CLKB is connected electrically to the light shielding film of the photodiode D2 via a contact.

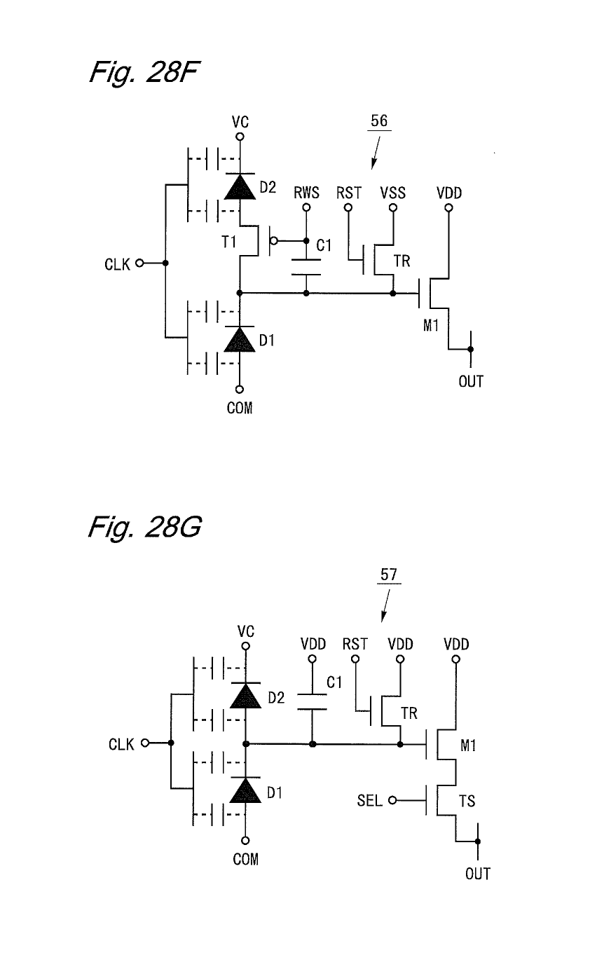

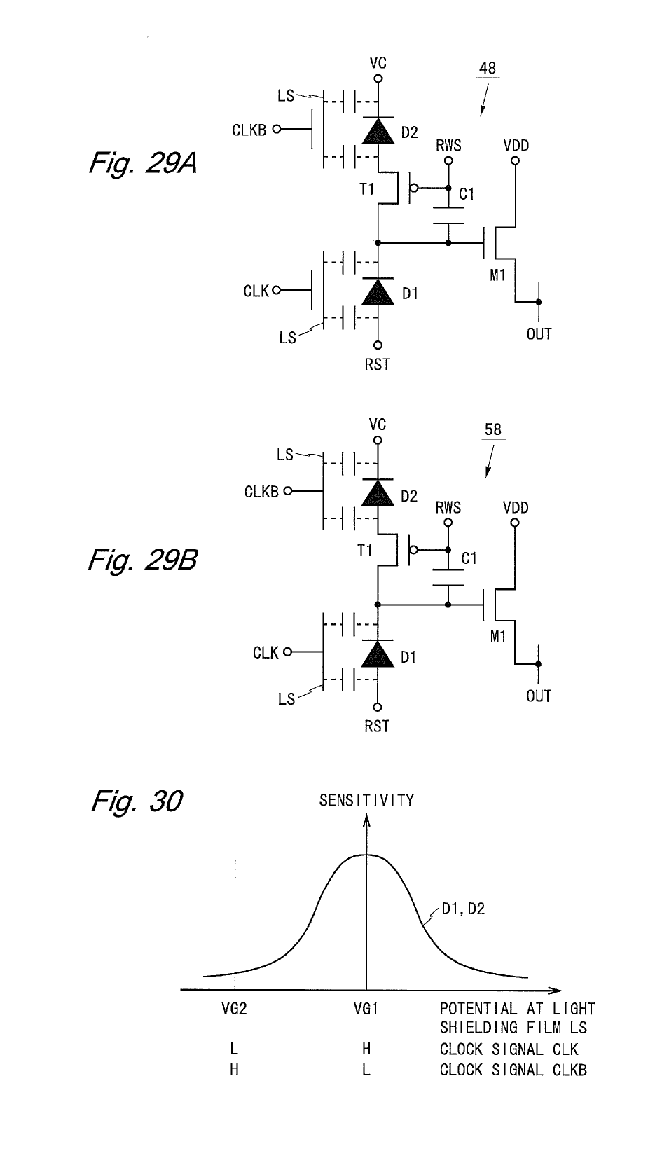

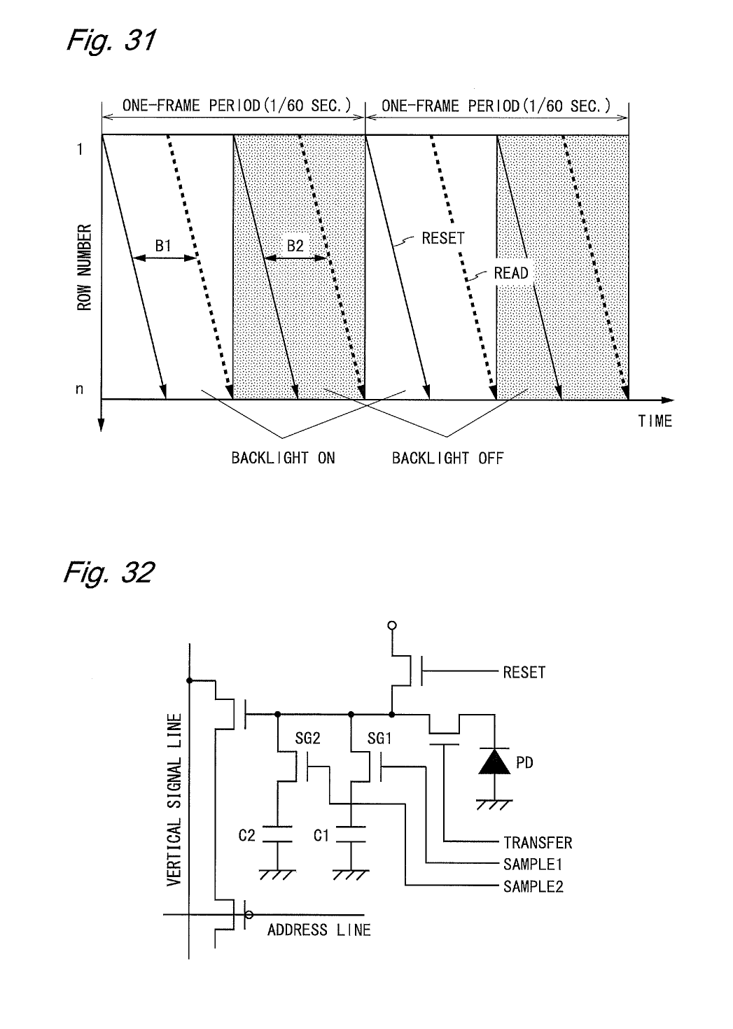

FIG. 30 is a diagram showing sensitivity characteristics of the photodiodes D1 and D2 included in each of the pixel circuits 48 and 58. As shown in FIG. 30, the photodiodes D1 and D2 are configured to have the same sensitivity characteristics. In the case where VG1 represents a potential at the light shielding film LS when the clock signal CLK is in a HIGH level (the clock signal CLKB is in a LOW level) and VG2 represents a potential at the light shielding film. LS when the clock signal CLK is in the LOW level (the clock signal CLKB is in the HIGH level), the photodiodes D1 and D2 are configured so that the sensitivity becomes relatively high when the potential at the light shielding film LS is VG1 and the sensitivity becomes relatively low when the potential at the light shielding film LS is VG2.

The photodiodes D1 and D2 having the sensitivity characteristics shown in FIG. 30 are controlled by use of the different clock signals CLK and CLKB. Thus, when a backlight is turned on, a current flowing through the photodiode D1 becomes larger in amount than a current flowing through the photodiode D2, and a potential at an accumulation node drops because of the current flowing through the photodiode D1. On the other hand, when the backlight is turned off, the current flowing through the photodiode D2 becomes larger in amount than the current flowing through the photodiode D1, and the potential at the accumulation node rises because of the current flowing through the photodiode D2. As described above, the potential at the accumulation node changes in reverse direction when the backlight is turned on and when the backlight is turned off. According to the pixel circuits 48 and 58, hence, as in the pixel circuits 40 and 50, it is possible to detect a difference between an amount of light when the backlight is turned on and an amount of light when the backlight is turned off, by use of one sensor pixel circuit.

Moreover, the first to fifth embodiments may employ various modification examples in such a manner that the modifications described above are combined arbitrarily without violating their properties.

As described above, in the display devices according to the embodiments of the present invention and the modification examples of the embodiments, it is possible to detect the difference between the amount of light when the backlight is turned on and the amount of light when the backlight is turned off, by use of the sensor pixel circuit including the two optical sensors, the one accumulation node and the transistor for read. Therefore, it is possible to solve the conventional problems and to give an input function which does not depend on light environments.

It is to be noted that the type of a light source to be provided on the display device is not particularly limited in the present invention. Accordingly, for example, a visible light backlight to be provided for display may be turned on and off a plurality of times, respectively, in a one-frame period. Alternatively, an infrared light backlight for light sensing may be provided separately from the visible light backlight for display on the display device. In such a display device, the visible light backlight may always be turned on, and only the infrared light backlight may be turned on and off a plurality of times, respectively, in the one-frame period.

### INDUSTRIAL APPLICABILITY

The display device according to the present invention is characterized by having an input function which does not depend on light environments, and therefore is applicable to various display devices in which a plurality of optical sensors are provided on a display panel.

### EXPLANATION OF REFERENCE SYMBOLS

1: Display control circuit
2: Display panel
3: Backlight
4: Pixel region
5: Gate driver circuit
6: Source driver circuit
7: Sensor row driver circuit
8: Display pixel circuit
9: Sensor pixel circuit
10 to 17, 20 to 27, 30 to 37, 40 to 48, 50 to 58: Pixel circuit

1. A display device in which a plurality of optical sensors are arranged in a pixel region, the display device comprising:
a display panel that includes a plurality of display pixel circuits and a plurality of sensor pixel circuits; and
a drive circuit that outputs, to the sensor pixel circuits, a control signal indicating that a light source is turned on or the light source is turned off, wherein
the sensor pixel circuit includes:
a first optical sensor;
a second optical sensor;
one accumulation node accumulating charge corresponding to an amount of sensed light; and
a read transistor having a control terminal connected to the accumulation node, and
the sensor pixel circuit is configured so that, in accordance with the control signal, a potential at the accumulation node is changed in a predetermined direction by a current flowing through the first optical sensor when the light source is turned on and is changed in the reverse direction by a current flowing through the second optical sensor when the light source is turned off.

2. The display device according to claim 1, wherein
the sensor pixel circuit further includes:
a first switching element that is provided on a path for the current flowing through the first optical sensor and turns on, in accordance with the control signal, when the light source is turned on; and
a second switching element that is provided on a path for the current flowing through the second optical sensor and turns on, in accordance with the control signal, when the light source is turned off.

3. The display device according to claim 2, wherein
the first optical sensor is provided between the accumulation node and one of ends of the first switching element,
the second optical sensor is provided between the accumulation node and one of ends of the second switching element,
the other end of the first switching element is connected to a reset line, and
the other end of the second switching element is applied with a predetermined potential.

4. The display device according to claim 2, wherein
the first switching element is provided between the accumulation node and one of ends of the first optical sensor,
the second switching element is provided between the accumulation node and one of ends of the second optical sensor,
the other end of the first optical sensor is connected to a reset line, and
the other end of the second optical sensor is applied with a predetermined potential.

5. The display device according to claim 3, wherein
the sensor pixel circuit further includes:
a third switching element that has one of ends connected to a first switching element side terminal of the first optical sensor and turns on, in accordance with the control signal, when the light source is turned off;
a fourth switching element that has one of ends connected to a second switching element side terminal of the second optical sensor and turns on, in accordance with the control signal, when the light source is turned on;
a fifth switching element supplying the other end of the third switching element with a potential corresponding to the potential at the accumulation node; and
a sixth switching element supplying the other end of the fourth switching element with a potential corresponding to the potential at the accumulation node.

6. The display device according to claim 2, wherein
the sensor pixel circuit further includes a capacitor provided between the accumulation node and a read line.

7. The display device according to claim 1, wherein
the first and second optical sensors have sensitivity characteristics that, in accordance with the control signal, the current flowing through the first optical sensor becomes larger in amount than the current flowing through the second optical sensor when the light source is turned on, and the current flowing through the second optical sensor becomes larger in amount than the current flowing through the first optical sensor when the light source is turned off.

8. The display device according to claim 7, wherein
a control line for propagating the control signal is connected to a light shielding film formed for the first and second optical sensors, via a capacitor.

9. The display device according to claim 7, wherein
a control line for propagating the control signal is electrically connected to a light shielding film formed for the first and second optical sensors.

10. The display device according to claim 7, wherein
the sensitivity characteristics of the first and second optical sensors change in different manners in accordance with the control signal, and the same control signal is supplied to the first and second optical sensors.

11. The display device according to claim 7, wherein
the sensitivity characteristics of the first and second optical sensors change in the same manner in accordance with the control signal, and an inverted signal of the control signal to be supplied to the first optical sensor is supplied to the second optical sensor.

12. The display device according to claim 7, wherein
the sensor pixel circuit further includes:
a capacitor provided between the accumulation node and a read line; and
a switching element that is provided between the accumulation node and one of ends of the second optical sensor and turns off when a potential for read is applied to the read line,
the first optical sensor is provided between the accumulation node and a reset line, and
the other end of the second optical sensor is applied with a predetermined potential.

13. The display device according to claim 1, wherein
the drive circuit outputs, as the control signal, a signal indicating that the light source is turned on and the light source is turned off a plurality of times, respectively, in a one-frame period.

14. A sensor pixel circuit to be arranged in a pixel region of a display device, the sensor pixel circuit comprising:
a first optical sensor;
a second optical sensor;
one accumulation node accumulating charge corresponding to an amount of sensed light; and
a read transistor having a control terminal connected to the accumulation node, wherein
the sensor pixel circuit is configured so that, in accordance with a control signal indicating that a light source is turned on or the light source is turned off, a potential at the accumulation node is changed in a predetermined direction by a current flowing through the first optical sensor when the light source is turned on and is changed in the reverse direction by a current flowing through the second optical sensor when the light source is turned off.
